(19) United States
(12) Patent Application Publication
(10) Pub. No.: US 2022/0282400 A1
(43) Pub. Date: Sep. 8, 2022

(54) CONFIGURABLE APPARATUS AND METHODS FOR DECORTICATING, COMMINUTING, AND LIBERATING FIBERS AND HURD FROM HEMP STALKS AND RELATED MATERIALS USING SELECTIVE DIFFERENTIAL FRAGMENTATION

(71) Applicant: Micronizing Technologies, LLC, Allen, TX (US)

(72) Inventors: Steven L. Sample, Ocala, FL (US); Edward W. Sample, Allen, TX (US)

(21) Appl. No.: 17/686,187

(22) Filed: Mar. 3, 2022

Related U.S. Application Data
(60) Provisional application No. 63/155,870, filed on Mar. 3, 2021.

(51) Int. Cl. D01B 1/44; D01B 1/26

(52) U.S. Cl. CPC D01B 1/44; D01B 1/26

(57) ABSTRACT

A revolutionary and totally unique apparatus relatively quickly and easily configurable and reconfigurable into more than 829,440 different combinations reduces the particle size of organic and inorganic materials, including components of hemp cultivars and kenaf stalks, from inches to microns in less than one second by gently pulling the structures apart along natural fracture planes and lines of cleavage rather than compressing the material to failure, while simultaneously liberating particles of complex multiphase materials one from the other using selective differential fragmentation, all without agglomeration. Strong shearing forces induced by thousands of incrementally-stepped, pulsed shock waves, vortexes of air, rapid pulsatile pressure changes, and piezoelectric effects at different levels in the apparatus combine to cause the material's elastic limits to be exceeded flowing through user-definable processing chambers characterized by alternating processing rotors and segmented divider plates embedded in hinged outer doors.

### CROSS-REFERENCE TO RELATED APPLICATIONS

This application claims priority to, and the benefit of, U.S. Provisional Patent Application Ser. No. 63/155,870 filed Mar. 3, 2021, and entitled “Process and Methods for Decorticating, Liberating, and Comminuting Hemp Fibers and Hurd from Hemp Stalks,” the disclosure of which is incorporated herein by reference in its entirety

### TECHNICAL FIELD

The present disclosure relates generally to methods for processing segments of raw hemp stalks to remove the hemp bast fiber material and the woody hemp hurd material using implementations of a prior art PulseWave Natural Resonance Disintegration (NRD) apparatus and implementations of a new PulseWave Quantum Decompiler (QD) apparatus as more fully described herein. In more detail, the present disclosure relates to apparatus and methods for decorticating, liberating, and comminuting hemp bast fiber and hemp hurd material from raw hemp stalks and related materials.

### BACKGROUND

Many plants, animals, bacteria, and fungi include useful material within their cells. These materials may be useful in pharmaceuticals, nutritional supplements, nutraceuticals, and the like. Others may have agricultural or industrial applications, for example, the bast fibers and woody hurd materials contained within hemp stalks. All plant and fungal cell walls are made primarily of cellulose, which is generally in the form of long, cross-linked strands. Such cell walls, which provide mechanical support for plants and fungi, are necessarily very sturdy and resistant to being easily opened or broken apart by mechanical or chemical means.

One method of breaking open plant or fungal cell walls to release the material inside is by grinding or milling the plant or fungal material using impact-based, kinetic devices. However, many cell walls are only crushed by grinding or milling with those devices and are not substantially broken open, and much desirable material can remain within the shells of the crushed cell walls. Grinding or milling the plant or fungal material also mixes together all material from the cells, including the cellulose, in a process referred to as agglomeration, which makes it difficult to separate the useful material from unwanted debris. The ground or milled product using impact-based milling or grinding devices is impure in that the product retains all impurities that were in the stock material before grinding or milling. Because each plant sample may contain a different content of impurities or inactive ingredients, the efficacy of the ground or milled product for its intended purpose can vary widely.

Another common method of opening cellulose cell walls to extract intracellular material is with the use of chemicals that break down the cellulose walls. These chemicals may include solvents or acids which may contaminate the desirable material within the cells. Additional processing may then be required to remove the chemicals, adding cost to the extraction process. The chemicals also may chemically alter the desired intracellular material, rendering it weakened, useless, or even harmful.

Another prior art method of removing desired components from intracellular materials, in this example bast fibers and hemp hurd from hemp stalks, involves a process called retting. Retting, which is actually related to rotting, is a process intended to remove noncellulosic materials attached on the fiber bundle by enzymatic activities, consequently yielding detached cellulosic fiber. Retting involves allowing microorganisms and moisture to rot or degrade the surface of the plant such that the pectin holding it together is slowly broken down. Retting processes can include dew retting, water retting, warm water retting, green retting, or chemical retting.

Chemical retting is considerably faster than the other processes, but includes the use of such chemicals and combinations of chemicals as: hydrogen peroxide, water, and sodium hydroxide; sodium hydroxide, sodium sulfide, and acetic acid; sodium carbonate, sodium hydroxide, and sodium sulfide; caustic soda; anthraquinone and sodium bisulphite and can include acidic souring and alkaline boiling. Many of those chemicals and processes can leave odors and/or substantial residues, often harmful to the environment. Contaminated water often shows exorbitant chemical oxygen demand, biological oxygen demand, total dissolved solids, sulfide content, and a blackish-brown color.

Besides polluting environments, the use of chemicals in the retting process increases the costs of operations. Suitable industrial processes for water and chemical retting have not been developed. Although retting can make it easier to remove bast fibers, it is a time-consuming, costly, and often pollutive process, and it is a primary cause of higher bacterial activity in hemp due to contamination.

Conventionally, hemp stalks have been processed in decortication machines to separate hemp bast fibers and hemp hurd (shiv) material by removal of at least portions of the inner layers of the hemp stalk thereof, generally relying upon processing in hammer mills, roller mills, ball mills, pin mills, knife mills and other crushing, grinding, and cutting devices, and many times a combination of several of these, the common denominator being the impact nature of the processes. In many instances, the hemp stalk materials are pretreated in a variety of ways such as with retting to promote a partial rotting process that is intended to weaken the fiber materials prior to processing in impact-based decorticating devices. In such mechanical impact processing, hemp bast fiber is liberated from hemp hurd (shiv) with relatively low efficiency combined with high waste being commonplace, especially when retting is made a part of the process. Hemp fiber in particular, while recommended for many uses, is processed in many prior art apparatuses with a resulting material characterized by the presence of damaged or shortened fibers, thus yielding a material not suitable for the expectations of components for modern manufacturing needs. Hemp hurd subjected to the same processes can also be damaged, including microbial contamination attendant to retting activities.

Traditional decorticating machines may include one or more sections containing some combination of crushing, squeezing, grooved, rasping, bladed, and/or toothed rollers, heated drying chambers, scutching blades, bands, traveling chains, spindles, tables, jaws, clamps, pulleys, cams, and other mechanical components that crush, grind, hammer, squeeze and cut the hemp stalk materials in the decorticating process, often with damage to the bast fiber portion of the material, rendering it less valuable or in some instances unusable for commercial purposes. Traditional decortication machines may cause mechanical damage, commonly referred to as “kink bands”, to hemp bast fiber. Typically, the drier the stalk and lesser the degree of retting, the higher the instance of mechanical damage. The kink bands substantially weaken the bast fiber, thereby limiting the range of end-use applications.

For example, when mechanically damaged bast fiber is subjected to wet processing, otherwise referred to as degumming, and additional mechanical processing such as carding, fine cleaning, or cottonization, the mechanically damaged fibers typically break into short segments under 10 mm (about 4/10 of an inch) in length, rendering attempts to add value through further processing economically unfeasible.

The PulseWave Quantum Decompiler (QD) apparatus of the present disclosure eliminates the vast majority of the shortcomings of prior art by an unprecedented apparatus incorporating unique implementations that are relatively quickly and easily configurable and reconfigurable as described herein for the purpose of generating specific combinations of forces, including but not limited to customizing the configuration to better enhance any desired level of shearing forces, particle-to-particle collisions, destructive resonance forces including resonance disintegration, and other contributory forces that are collectively referred to herein as the “PulseWave QD Forces,” all of which generally occur within less than one second during passage of materials through the PulseWave QD apparatus.

In addressing shortcomings of prior art impact-based technology, implementations of the apparatus described herein provide for superior and economical processing of hemp stalks and related materials such as Cannabis and kenaf stalks whereby fiber materials are liberated from woody hurd materials during processing without the requirement for a decorticator.

### SUMMARY

The beneficial uses of hemp fibers and hemp hurd have been known since the beginnings of recorded history, but it is only recently that the components can be efficiently and economically liberated from the plant stalk material in implementations of the PulseWave apparatuses.

The present disclosure is directed to a unique and abundantly configurable PulseWave Quantum Decompiler (QD) apparatus. In some implementations, the PulseWave QD apparatus can relatively quickly and easily be configured and reconfigured into more than 829,440¹ different combinations and recombinations to more efficiently and economically comminute a wide range of materials, for example hemp and kenaf stalks, to smaller sizes while liberating the components of complex, multiphase materials one from the other by using selective differential fragmentation utilizing methods as set forth herein. ¹See Appendix for Mathematician's Report of available combinations of configuring and reconfiguring the PulseWave QD apparatus.

The present disclosure is further directed to methods for producing hemp bast fibers from raw hemp stalk segments utilizing either the PulseWave Quantum Decompiler (QD) apparatus or the prior art PulseWave Natural Resonance Disintegration (NRD) apparatus for quickly and efficiently decorticating, comminuting, and liberating fibers and hurd from hemp stalks and related materials using selective differential fragmentation as more fully described herein. The methods may comprise subjecting at least one raw hemp stalk segment to processing substantially without mechanical impact in implementations of either of said apparatuses to liberate and, per se, decorticate the hemp bast fibers from the raw hemp stalk segment commensurate with the use of such fibers as a component in commercial products without the use of a stand-alone external decorticator or a retting process. Both PulseWave apparatuses and methods can similarly be utilized to efficiently liberate the fibers and woody core materials from kenaf stalks without requiring an external decorticator or the use of retting prior to processing. The non-impact processing may comprise processing using resonance disintegration and/or other forces referred to herein as the PulseWave QD Forces.

The methods may further optionally comprise blending an additive with the hemp stalk material by subjecting a combination of the hemp stalk material and the additive to processing in an apparatus using resonance disintegration and/or PulseWave QD Forces. The hemp bast fibers produced by the apparatuses and methods may have a reduced moisture content after liberation sufficient to cause the processed materials to be more resistant to spoilage. The hemp bast fibers liberated by processing in implementations of the apparatuses may also be resistant to clumping together of the particles.

The present disclosure is further directed to using implementations of the PulseWave QD apparatus or the PulseWave NRD apparatus in conjunction with methods for removing hemp bast fibers from other components of hemp stalk materials comprising liberating the hemp bast fibers by selective differential fragmentation of particles in complex multi-phase materials in a resonance decortication process. The methods may comprise subjecting the hemp stalk materials to resonance disintegration processing and/or other PulseWave QD Forces for liberating the fiber and pulp components of the hemp material from one another. The methods may further comprise liberating the hemp bast fiber component of the hemp stalk material subsequent to subjecting the hemp stalk material to processing that can include increased particle-to-particle collisions within a relatively more chaotic fluid stream within the uniquely configurable PulseWave QD apparatus.

The present disclosure is further directed to using implementations of the PulseWave QD apparatus or the PulseWave NRD apparatus in conjunction with methods for comminuting hemp bast fibers liberated from raw hemp stalk segments comprising subjecting at least one hemp stalk segment to non-impact processing to liberate the hemp bast fibers from the raw hemp stalk segment commensurate with the use of such fibers as a component in commercial products. The non-impact methods of processing materials in implementations of either PulseWave apparatus may further comprise liberating the hemp bast fibers using resonance disintegration processing and/or other PulseWave QD Forces in preserving the quality and integrity of the finished product.

The present disclosure is further directed to a composition of matter comprising hemp bast fibers produced from hemp stalk materials having oils inherent in said stalks, wherein particles of the hemp bast fibers liberated by the PulseWave apparatuses and methods have relatively reduced quantities of said oils on surfaces of said particles as compared to particles of hemp bast fibers produced by conventional prior art impact processing including the use of retting and being subjected to decorticating machines. The particles of hemp bast fibers produced utilizing implementations of the PulseWave QD apparatus or the PulseWave NRD apparatus in conjunction with the methods may further comprise reduced levels of oxidation products of one or more oils inherently present in the raw hemp materials compared to hemp bast fibers produced by conventional impact processing methods, sometimes in conjunction with a retting process.

The present disclosure is further directed to using implementations of the PulseWave QD apparatus or the PulseWave NRD apparatus in conjunction with methods for improving the environment and health of a living being, comprising producing a non-pollutive hemp bast fiber material from a hemp stalk material, the hemp bast fiber material being substantially useful as an ingredient in environmentally-friendly commercial products that, if comminuted and liberated according to the present disclosure, can reduce pollution and hazards to the environment and to living beings. The resulting hemp bast fiber material may be suitable for use as a component or pre-component of ingredients for nonwoven geotextiles/matting, woven and non-woven insulation, substitutes for carbon fiber, glass fiber, and fiberglass, industrial fabrics, alloys blended with metals, automotive components (such as door panels, dashboards, etc.), shoes, ropes, clothing and textiles, and supercapacitors. The hemp bast fiber material may be produced by subjecting hemp stalk materials to resonance disintegration and/or other PulseWave QD Forces in implementations of the PulseWave apparatuses.

The present disclosure is further directed to methods for producing hemp hurd (shiv) material from raw hemp stalk segments. The methods may comprise subjecting at least one hemp stalk segment to processing substantially without mechanical impact using resonance disintegration and/or other PulseWave QD Forces as defined herein to liberate and, per se, decorticate the hurd material from the raw hemp stalk segment commensurate with the use of such woody hurd material as a component in commercial products.

The methods may further comprise optionally blending an additive with the hemp hurd material by subjecting a combination of the hemp hurd material and the additive to resonance disintegration and/or other PulseWave QD Forces. When using the PulseWave QD apparatus or the PulseWave NRD apparatus in conjunction with the methods described herein, the hemp hurd material may be processed to various particle sizes ranging from approximately 25 to 100 microns or to larger sizes by selecting various rotational speeds of the processing rotors in the range of generally approximately 500 to 5,000 rpm, and by selecting the preferred direction of rotation of the processing rotors. The PulseWave apparatuses can be made to render smaller particle sizes by selecting higher rotational speeds of the processing rotors generally in the range of 2,500 to 5,000 rpm, while larger particle sizes can be rendered by selecting slower rotational speeds of the processing rotors generally in the range of approximately 500 to 2,500 rpm and selecting the preferred direction of rotation of the processing rotors at any given speed. Processing in the PulseWave QD apparatus may be further enhanced by relatively quickly and easily configuring or reconfiguring the various components of the apparatus to favor the material being processed.

The hemp hurd material produced in implementations of the PulseWave apparatuses in conjunction with the methods disclosed herein may have a reduced moisture content after formation by processing using resonance disintegration and/or other PulseWave QD Forces sufficient to render the material more resistant to spoilage relative to hurd material prepared by conventional impact processes, sometimes in conjunction with a retting process. The hemp hurd material so processed using resonance disintegration and/or other PulseWave QD Forces may further be resistant to clumping together of the particles.

The process and methods may cause the hemp hurd material processed in implementations of the PulseWave apparatuses to exhibit a low bacterial level relative to hurd material prepared by conventional impact processes, sometimes in conjunction with a retting process. The methods of the present disclosures may use raw hemp stalk materials selected from the group consisting of the stalks and/or stems of hemp plants as a variety of Cannabis sativa plant cultivars as varieties grown for industrial and commercial use. The process and methods can also be similarly effective in processing stalks of kenaf plants.

The present disclosure is further directed to using implementations of the PulseWave QD apparatus or the PulseWave NRD apparatus in conjunction with the methods for removing hemp hurd materials from other components of the hemp stalk materials that, if comminuted and liberated according to the present disclosure, utilizes selective differential fragmentation of particles in complex multi-phase materials in a decortication process subjecting the hemp stalk materials to resonance disintegration and/or other PulseWave QD Forces in liberating the fiber and hurd components of the hemp material without the need for an external decorticator or a retting process.

The present disclosure is further directed to using implementations of the PulseWave QD apparatus or the PulseWave NRD apparatus in conjunction with the methods for comminuting hemp hurd materials liberated from raw hemp stalk segments comprising subjecting at least one hemp stalk segment to non-impact processing to reduce the size of the hurd from the raw hemp stalk segment commensurate with the use of such hurd as a component in commercial products. The non-impact processing in the apparatuses may comprise using resonance disintegration and/or other PulseWave QD Forces. The methods may further comprise reducing the size of the hurd to a desired outcome.

The present disclosure is further directed to a composition of matter comprising hemp hurd material produced from hemp stalk materials having oils inherent in said stalks, by subjecting them to resonance disintegration and/or other PulseWave QD Forces wherein particles of the hurd have relatively reduced quantities of said oils on surfaces of said particles as compared to particles of hurd produced by conventional processing. The particles of hemp hurd material so produced may further comprise reduced levels of oxidation products of said oils.

The present disclosure is further directed to a hemp hurd material processed in implementations of either of the PulseWave apparatuses without any retting process and having core values substantially identical to said values of raw hemp materials from which the hurd is formed. The hurd may further include reduced levels of oxidation products of one or more oils inherently present in the raw hemp materials compared to hurd produced by conventional impact processing methods, sometimes in conjunction with a retting process.

The present disclosure is further directed to methods for improving the environment and health of a living being, comprising producing a non-pollutive hemp hurd material from a hemp stalk material by subjecting hemp stalk materials to processing in one or more implementations of the PulseWave NRD apparatus or the PulseWave QD apparatus using methods set forth herein in conjunction with resonance disintegration and/or other PulseWave QD Forces, the hurd being substantially useful as an ingredient in environmentally-friendly products that, if comminuted and liberated according to the present disclosure, can reduce pollution and hazards to the environment and to living beings. The resulting hurd material may be suitable for use as a component or pre-component of ingredients for bioplastics, plastic additives, absorbents, animal bedding, animal litter, mulch & biochar, wood substitutes, paper & pulp, hemperete, particleboard, cellulose, as a replacement for talc or calcium carbonate, and as components in lime plaster.

The present disclosure is further directed to a composition of matter produced using implementations of the prior art PulseWave NRD apparatus as described in cited patents incorporated herein by reference and using one or more implementations of the new PulseWave QD apparatus as set forth in the descriptions below.

While the present disclosure depicts and describes certain implementations of the PulseWave QD apparatus and various processes, systems, methods, and compositions of matter, there is no intent to limit the present disclosures thereto. On the contrary, the intent is to cover all alternatives, modifications and equivalents as included within the spirit and scope of the present disclosure as defined by the appended claims.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the implementations of the disclosure.

For a more complete understanding of this disclosure and its features, reference is now made to the following description, taken in conjunction with the accompanying drawings, in which:

FIG. 1A illustrates an elevation view, partially in cross-section, of an implementation of a PulseWave Quantum Decompiler (QD) apparatus 1 rotationally coupled to an electric drive motor 5 with direct drive coupler 14, all affixed to a common mounting pillar 13, with feed hopper and chute 27, and product discharge chute 48, according to the present disclosure.

FIG. 1B illustrates a perspective side view of the PulseWave QD apparatus 1 with hinged, removable outer doors 7 rotated into the open position, the PulseWave QD apparatus 1 rotationally coupled to an electric drive motor 5 on hinged mounting plate 19 with direct drive coupler 14, all affixed to a common mounting pillar 13, with feed hopper and chute 27 affixed to the mill top plate 30, according to the present disclosure.

FIG. 1C illustrates a perspective side view of the PulseWave QD apparatus 1 with hinged, removable outer doors 7 mounted on a hinge pin 10 and rotated into the open position to show internal processing rotors 22, according to the present disclosure.

FIG. 2A illustrates a cross-sectional elevation view of an implementation of the PulseWave QD apparatus 100 with six processing chambers including inlet chamber 54, discharge chamber 53, and four standard chambers 21 thereinbetween, the respective chambers containing a distributor rotor 32, a discharge rotor 55, and four standard processing rotors 22 thereinbetween, according to the present disclosure.

FIG. 2B illustrates a cross-sectional elevation view of another implementation of the PulseWave QD apparatus 110 with four processing chambers including inlet chamber 54, discharge chamber 53, and two standard chambers 21 thereinbetween, the respective chambers containing a distributor rotor 32, discharge rotor 55, and two standard processing rotors 22 thereinbetween, according to the present disclosure.

FIG. 3A illustrates a plan view of an implementation of a common nonagonal-shaped processing rotor 22 with nine semi-curved processing rotor vanes 11 extending inwardly from the outer apices to the inner hub of the processing rotor 22, nine rectangular-shaped Secondary Battlement Vortex Disrupters 29 incorporated into the outer edges thereof, and grooves for O-Rings 50, according to the present disclosure.

FIG. 3B illustrates a cross-sectional end view of an implementation of a processing rotor vane 23 incorporating an enlarged, annular top edge and flat sides, according to the present disclosure.

FIG. 3C illustrates a cross-sectional end view of an implementation of a processing rotor vane 24 incorporating a flat top edge and a concave side in the clockwise direction of rotation.

FIG. 3D illustrates an elevation view of the processing rotor 22 of FIG. 3A according to the present disclosure.

FIG. 4A illustrates a top cutaway plan view of a processing chamber 21 of the PulseWave QD apparatus 1 of FIG. 2A with the hinged, removable outer doors 7 rotated to the closed position and forming an orifice 40 at the center thereof that would encircle the central rotating shaft 3 of the PulseWave QD apparatus 1, according to the present disclosure.

FIG. 4B illustrates a top cutaway plan view of the PulseWave QD apparatus 1 of FIG. 2A with the three hinged, removable outer doors 7 rotated to the open position on hinge pins 10, according to the present disclosure.

FIG. 5A illustrates an inside perspective view, partially in cross-section, of an implementation of a hinged, removable outer door 7 of the PulseWave QD apparatus 1 of FIG. 2B in an optional four processing chamber implementation, according to the present disclosure.

FIG. 5B illustrates an outside perspective view, partially in cross-section, of the hinged, removable outer door 7 of FIG. 5A, according to the present disclosure.

FIG. 6A illustrates a plan view of one implementation of a Type 2 processing rotor 46 showing 6⅔ degrees of rotational offset of the splined central hub versus a Type 1 processing rotor 45, a square-cornered rectangular Secondary Battlement Vortex Disrupter 29, a semi-curved processing rotor vane 11, and grooves for O-Rings 50, according to the present disclosure.

FIG. 6B illustrates an elevation view of one implementation of three processing rotors of Type 1 45, Type 2 46, and Type 3 47 affixed to the central rotating shaft 3 at counterclockwise rotational offsets of 6⅔ degrees from one another when aligned evenly on the same splines, meaning the bottom processing rotor 47 of the three would be 13⅓ degrees rotationally offset in a counterclockwise from the top processing rotor 45 of the three, according to the present disclosure.

FIG. 7A illustrates a perspective view of an implementation of a splined central rotating shaft 3 of the PulseWave QD apparatus 100 of FIG. 2A with a limiting collar for utilization in conjunction with a standard roller type thrust bearing at the bottom of central rotating shaft 3, according to the present disclosure.

FIG. 7B illustrates a plan view of another implementation of a splined central rotating shaft 3 of the PulseWave QD apparatus 100 of FIG. 2A with a limiting collar for utilization in conjunction with optional low friction air bearings for vertical thrust support at the bottom of central rotating shaft 3, according to the present disclosure.

FIG. 8A illustrates a quartering perspective view of an implementation of a splined shaft spacer 49 for insertion between adjacent processing rotors 22 to define the distance separating one from the other for proper centering within the processing chambers 21, according to the present disclosure.

FIG. 8B illustrates a plan view of the splined shaft spacer 49 of FIG. 8A with grooves for O-Rings 50, according to the present disclosure.

FIG. 9 illustrates a plan view of a mill top plate 30 of the PulseWave QD apparatus 1 of FIG. 1A with two inlet ports 16 disposed therein and one feed hopper and chute 27 affixed to one of the inlet ports 16, according to the present disclosure.

FIG. 10 illustrates a plan view of an implementation of a mill bottom plate 51 of the PulseWave QD apparatus 1 of FIG. 1A, according to the present disclosure.

FIG. 11A illustrates an elevation view of an implementation of an outer periphery of a processing rotor having a generally round shape and no Secondary Battlement Vortex Disrupters, according to the present disclosure.

FIG. 11B illustrates an elevation view of an implementation of an outer periphery of a nonagonal-shaped processing rotor having a generally flat shape with a Secondary Battlement Vortex Disrupter that is generally rectangular with radiused corners, according to the present disclosure.

FIG. 11C illustrates an elevation view of an implementation of an outer periphery of a nonagonal-shaped processing rotor having a generally flat shape with a Secondary Battlement Vortex Disrupter that is generally rectangular with squared corners, according to the present disclosure.

FIG. 11D illustrates an elevation view of an implementation of an outer periphery of a nonagonal-shaped processing rotor having a generally flat shape with a Secondary Battlement Vortex Disrupter that is generally in the shape of a half octagon, according to the present disclosure.

FIG. 11E illustrates an elevation view of an implementation of an outer periphery of a nonagonal-shaped processing rotor having a generally flat shape with a Secondary Battlement Vortex Disrupter that is generally elliptical, according to the present disclosure

FIG. 12A illustrates a quartering perspective view of an implementation of a splined air bearing platen 35 with locating pin hole 38 and grooves for O-Rings 50, according to the present disclosure.

FIG. 12B illustrates an elevation view of the splined air bearing platen 35 of FIG. 12A with locating pin hole 38 and grooves for O-Rings 50, according to the present disclosure.

FIG. 12C illustrates a plan view of an implementation of a splined internal mill discharge aspirator 44 with airfoil and grooves for O-Rings 50, according to the present disclosure.

FIG. 12D illustrates a quartering perspective view of the splined internal mill discharge aspirator 44 of FIG. 12C with airfoil and grooves for O-Rings 50, according to the present disclosure.

FIG. 13A illustrates a perspective view of one implementation of a segmented divider (orifice) plate 18 in one processing chamber 21 of the PulseWave QD apparatus 100 of FIG. 2A, three of which when formed together constitute a complete divider (orifice) plate, according to the present disclosure.

FIG. 13B illustrates a perspective view of a segmented divider plate spacer 52 that is substituted for a segmented divider (orifice) plate 18 to accommodate Primary Vortex Disrupter Pins 17 to maintain the integrity of the processing chambers when changing the number of or combining processing chambers within the PulseWave QD apparatus 100, according to the present disclosure.

FIG. 14A illustrates a side cross-sectional view of the upper two chambers of the PulseWave QD apparatus 100 of FIG. 2A, depicting the logical path of material flow in the material stream 34 after being introduced into the feed hopper and tube 27, passing through the mill top plate 30 and into the top processing chamber 54, and being first moved by the distributor rotor 32 into the second processing chamber 21 as it becomes a part of the Coanda flow 41 as it streams around segmented divider (orifice) plates 18 formed in the hinged, removable outer doors 7 of the apparatus 100, according to the present disclosure.

FIG. 14B illustrates a plan view of the PulseWave QD apparatus 100 of FIG. 2A with segmented wear plate assemblies 15 held in position by retainer plates 20, and by retainer rods 12 passing through retainer rod apertures 28, depicting the simulated flow of materials being processed in the fluid stream 34 with disruptions 9 as the stream passes over Primary Vortex Disrupter Pins 17.

FIG. 15 illustrates a detailed cutaway plan view of a portion of the segmented divider (orifice) plate 18 as illustrated in FIG. 4B and FIG. 5A but in greater detail with a two Primary Vortex Disrupter Pins 17 attached to segmented wear plate assembly 15, an accessory port 33, retainer plates 20 and retainer plate apertures 28.

FIG. 16 illustrates an elevation view of a prior art PulseWave Natural Resonance Disintegration (NRD) apparatus 56 in upper frame assembly 67 and lower frame assembly with operator's platform 68 electric drive motor 59 with serrated drive motor shaft pulley 61 coupled to mill shaft pulley 60 by serrated drive belt 62 with feed hopper and chute 66 affixed to the mill top plate 69, and illustrating upper discharge chute 71, lower discharge chute 72, and lower discharge cone 73.

FIG. 17 illustrates an elevation view of the PulseWave NRD apparatus 56 of FIG. 16 positioned within upper frame 67 beside horizontal drive electric motor 59, with fixed, bolted outer side plates 64 and fixed, bolted corner (cover) plates 65.

FIG. 18 illustrates a cross-sectional elevation view of the PulseWave NRD apparatus 56 of FIG. 16 with central rotating shaft 58 with keyways 80, upper and lower bearing housings 57, distributor rotor 74 in inlet chamber 77, discharge rotor 76 in discharge chamber 79, other processing rotors 75 in processing chambers 78, processing rotor vanes 83, segmented divider (orifice) plates 81, and orifice 82 formed around central rotating shaft 58.

Like reference symbols in the various drawings indicate like elements.

Other features, objects, and advantages of one or more of the implementations will be apparent from the details set forth in the accompanying drawings and the descriptions below

### DETAILED DESCRIPTION

Various modifications to the described implementations of the unique PulseWave QD apparatus will be readily apparent to those skilled in the art, and the generic principles taught herein may be applied to other implementations. Comparisons of the new PulseWave QD apparatus are made to the prior art PulseWave NRD apparatus herein. Thus, the present disclosures are not intended to be limited to the implementations shown, but are to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology has been adopted for purposes of enhancing the reader's understanding with respect to the various views provided in the figures, and is in no way intended as being limiting.

The PulseWave QD apparatus of the present disclosure is the first known apparatus to embody a unique design allowing for relatively rapid deployment of the apparatus in implementations containing three to six processing chambers while allowing relatively quick and easy access to the internal components thereof as facilitated by inclusion of multiple hinged, removable outer doors that define the boundaries of the processing chambers and the outer periphery of the apparatus and which quickly rotate open and closed to allow for rapid inspection, cleaning, repair, removal, replacement, configuration, and reconfiguration thereof.

In a manner heretofore not possible, the PulseWave QD apparatus of the present disclosure allows for various configurations that can efficiently reduce the particle size of particular various biological and non-biological materials composed of wet or dry discrete objects into relatively smaller micronic or submicronic particles by flowing the material through a relatively quickly and easily configurable and reconfigurable apparatus. The PulseWave QD apparatus of the present disclosure provides a great many different combinations and recombinations of three to six processing chambers, each containing processing rotors with or without processing rotor vanes of various configurations, and segmented divider plates of various sizes, shapes, relative geometry, and numbers with various sizes of orifices at the centers thereof such as to more efficiently process any given material.

The more uniquely configurable PulseWave QD apparatus and the prior art PulseWave NRD apparatus can efficiently expose the processed material to a combination of forces including inter alia: (i) rapid pulsatile compression and decompression of air and particles as they are driven through the machine by spinning processing rotors resulting in rapidly increasing and decreasing pressure changes that generate strong pulses of shock waves; (ii) machine design geometry that provides for thousands of pulsed waves and an incremental increase in the magnitude of the shock waves at different levels in the machine; (iii); the introduction of piezoelectric forces that act upon the objects; (iv) vortex-generated shearing forces that are phased for delivery just at the time particles approach and exceed their inherent natural limit of elasticity; (v) limited particle-to-machine collisions; and, (vi) rapid changes of direction of the flow in a high velocity fluid stream that induces particle-to-particle collisions within the apparatus. The forces delivered upon the objects by either of the PulseWave apparatus using the process and methods described herein generally combine to impart resonance frequencies to the material being processed, thus exposing the material to resonance disintegration of the bonds that hold the objects together in reducing particle size while being aided by the internal particle-to-particle collisions that further weaken the bonds. In addition, the PulseWave QD apparatus disclosed herein may be configured to generate additional forces on the material, which are referred to herein as the PulseWave QD Forces.

Actions in both PulseWave apparatuses collectively include thousands of incremental steps within the apparatus that act to selectively differentiate and fragment particles in complex multi-phase materials in a process referred to herein as liberation. Design features of the apparatus provide for phasing of forces enhancing the efficiency and smoothness of operation such that energy transfer to the machine itself is greatly minimized, aided in substantial part by the benefits of Coanda flow 41 as hereinafter described. The methods of the disclosure further reduce moisture content of the materials by subjection of such materials to the effects of the forces acting upon them.

In various implementations, the PulseWave QD apparatus of the present disclosure is relatively quickly and easily configurable and reconfigurable into at least 829,440¹ various optional and unique combinations to create shearing forces, semi-selective particle-to-particle or particle-to-machine collisions, destructive resonance forces that occur within less than one second of passage through the apparatus, and other contributory forces that are collectively referred to herein as the PulseWave QD Forces. ¹See Appendix for Mathematician's Report of available combinations of configuring and reconfiguring the PulseWave QD apparatus.

Because of the many unique aspects of the PulseWave Quantum Decompiler (QD) apparatus, and unlike any prior art, the present disclosure relates to a revolutionary new milling apparatus that is relatively quickly and easily configurable or reconfigurable into different combinations and recombinations for configuring the apparatus to more efficiently and economically reduce the particle size of a very wide range of specific organic and inorganic materials from inches to microns in less than one second while simultaneously liberating the particles of complex multiphase materials one from the other using selective differential fragmentation and at the same time removing significant moisture content. This is all accomplished with significantly less or no agglomeration or “smearing” of the processed materials as occurs in fixed design prior art impact-based milling apparatus embedded in kinetic-based technology. Examples of impact-based comminution devices include ball, roller, cone, pin, hammer and jet mills. The general capability of various predominant forces in impact-based mills varies relative to the kind of material processed, such as hardness, strength, and elasticity.

The PulseWave QD apparatus operates at lower energy costs as compared to prior art impact-based milling devices for the same volumes of work done as a result of the more efficient configurations that can be selected for a given material. The PulseWave QD mill is the first and only milling apparatus ever to attain these unique milestones heretofore not achieved by any prior art or device.

The unique PulseWave QD apparatus is relatively quickly and easily configurable into different configurations resulting in an unprecedented opportunity for the same machine to be adapted to more efficiently and economically process a wide range of various materials, quite unlike any other known apparatus. This unparalleled configurability is possible because the apparatus contains features that are unique and diverse from any other prior art comminution device.

### Structural Description

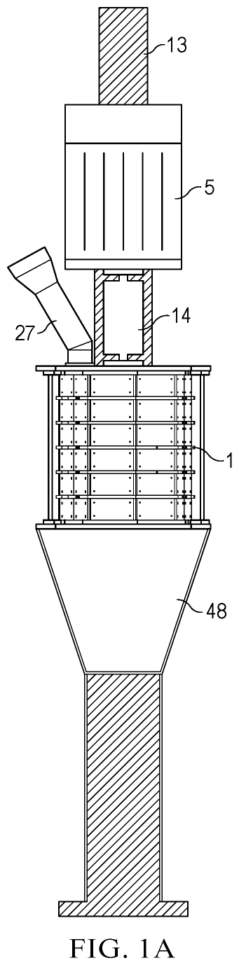

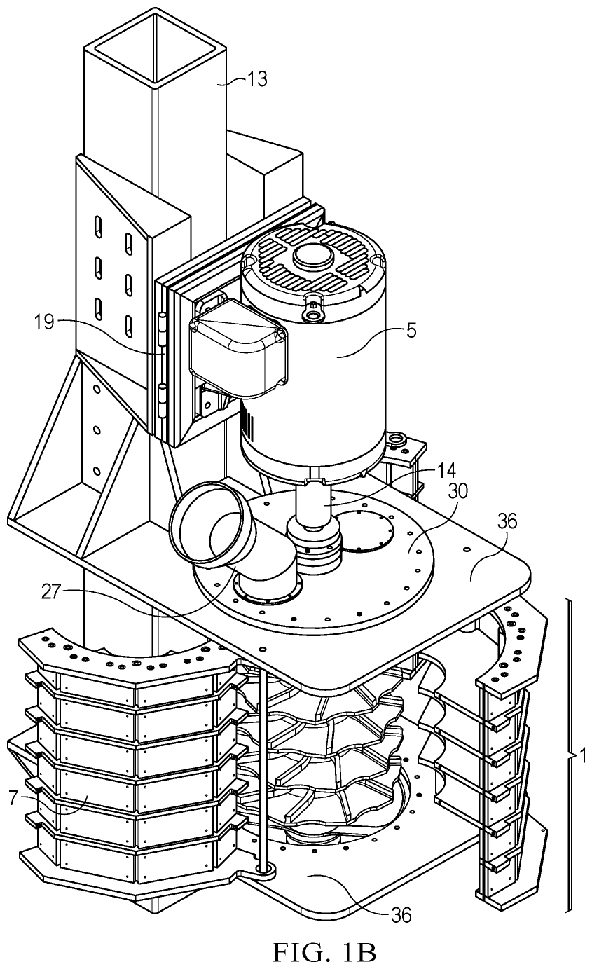

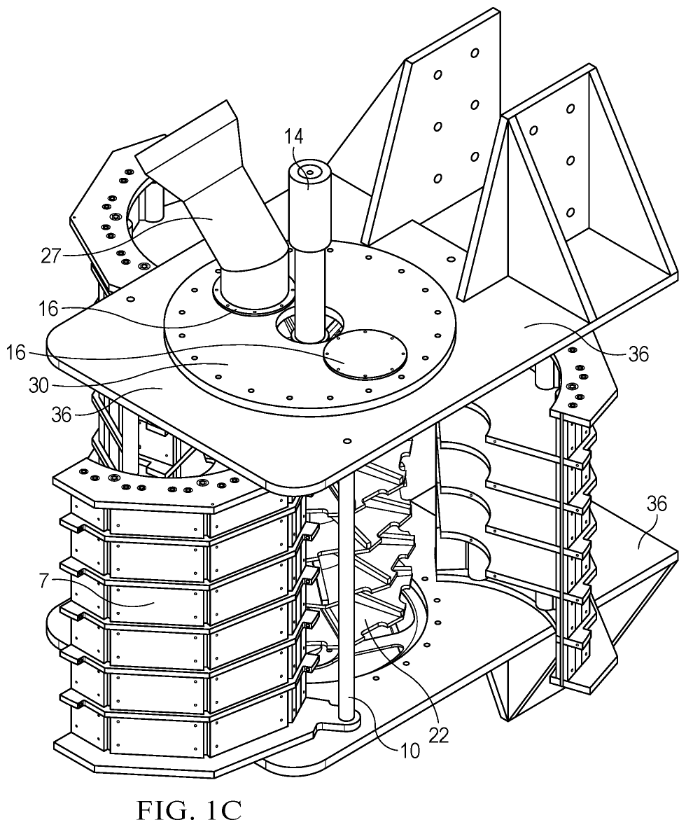

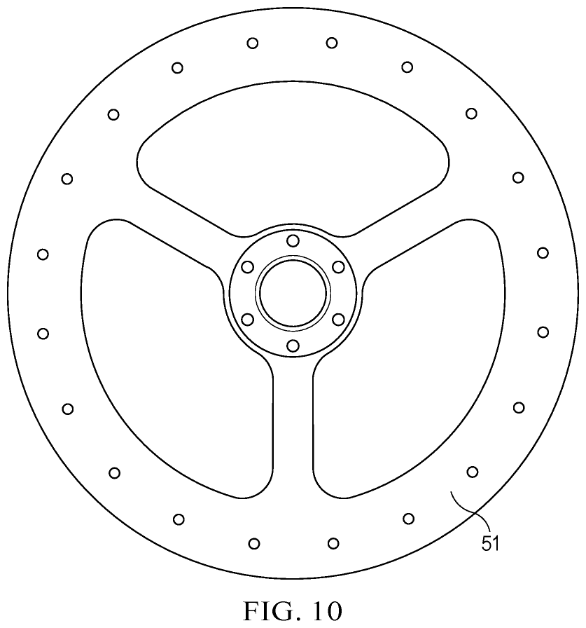

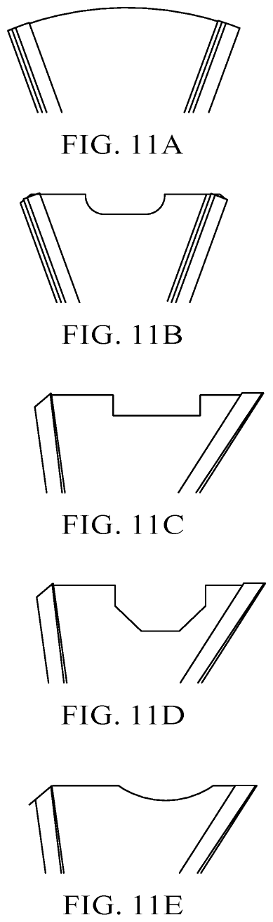

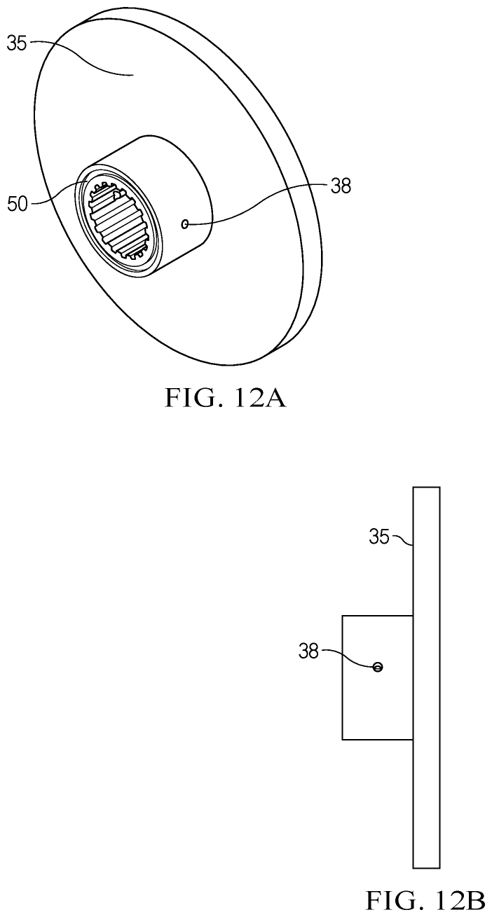

The following Reference Numbers 1-55, 100, and 110 are used in FIGS. 1A to 15 in describing the new PulseWave Quantum Decompiler (QD) apparatus:
1. PulseWave Quantum Decompiler (QD) apparatus
2. Housing for standard roller bearings on central rotating shaft
3. Splined central rotating shaft
4. Splined harmonic balancer
5. Electric drive motor
6. Primary fluid injection port
7. Hinged, removable outer doors of apparatus
8. Secondary fluid injection port
9. Fluid stream disruptions around Primary Vortex Disrupter Pins
10. Hinge pin to affix hinged, removable outer doors 7 to top and bottom machine mounting plates 36
11. Straight, curved, or semi-curved processing rotor vane
12. Retainer rod
13. Common mounting pillar
14. Direct drive mill to motor shaft coupler
15. Segmented wear plate assembly
16. Inlet ports in mill top plate
17. Primary Vortex Disrupter Pin
18. Segmented divider (orifice) plate
19. Hinged mounting plate for electric drive motor
20. Retainer plates
21. Processing chamber
22. Processing rotor
23. Processing rotor vane incorporating an enlarged, annular top edge and flat sides
24. Processing rotor vane incorporating a flat top edge and a concave side in the clockwise direction of rotation
25. Segmented top machine ring
26. Segmented bottom machine ring
27. Material feed hopper and chute
28. Retainer rod aperture
29. Secondary Battlement Vortex Disrupters
30. Mill top (inlet) plate
31. Incoming raw material
32. Topmost processing rotor, also sometimes referred to as the distributor rotor
33. Accessory port
34. Material flow in fluid stream
35. Splined air bearing platen
36. Machine mounting plate (top and bottom)
37. Involute splines on central rotating shaft, processing rotor hubs, splined shaft spacers
38. Locating pin hole in splined hub
39. Slot for positioning Primary Vortex Disrupter Pin in a segmented divider (orifice) plate
40. Orifice formed at center of a segmented divider plate
41. Coanda effect
42. Disruptions in flow
43. Low friction air bearing
44. Internal mill discharge aspirator
45. Type 1 processing rotor
46. Type 2 processing rotor
47. Type 3 processing rotor
48. Product discharge chute
49. Splined shaft spacer
50. O-ring grooves
51. Mill bottom (discharge) plate
52. Segmented divider plate spacer
53. Bottommost processing chamber, also sometimes referred to as the discharge chamber
54. Topmost processing chamber, sometimes referred to as the inlet chamber
55. Bottommost processing rotor, sometimes referred to as the discharge rotor
100. PulseWave QD apparatus with six processing chambers
110. PulseWave QD apparatus with four processing chambers

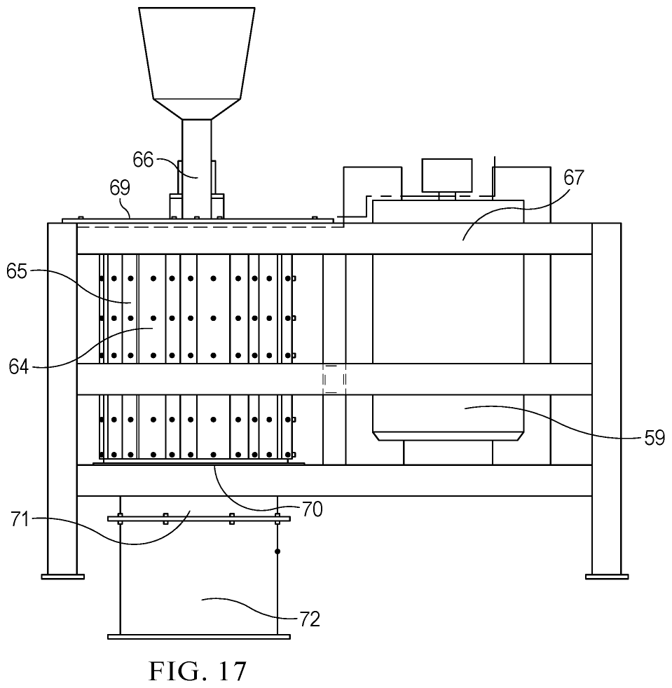

The following Reference Numbers 56-86 are used in the FIGS. 16-18 in describing the prior art PulseWave Natural Resonance Disintegration (NRD) apparatus:
56. PulseWave Natural Resonance Disintegration (NRD) apparatus
57. Bearing housings
58. Keyed central rotating shaft
59. Electric drive motor
60. Mill shaft pulley (sheave)
61. Electric motor shaft pulley (sheave)
62. Serrated drive belt
63. Safety guard for belt and pulleys
64. Mill side plate
65. Mill corner (cover) plate
66. Material feed hopper and chute
67. Upper frame for NRD mill apparatus and electric drive motor
68. Lower frame assembly with operator platform
69. Mill top (inlet) plate
70. Mill bottom (discharge) plate
71. Upper discharge chute
72. Lower discharge chute
73. Lower discharge cone
74. Topmost processing rotor, sometimes referred to as inlet or distributor rotor
75. Processing rotor
76. Bottommost processing rotor, sometimes referred to as discharge rotor
77. Topmost processing chamber, sometimes referred to as inlet chamber
78. Processing chamber
79. Bottommost processing chamber, sometimes referred to as discharge rotor
80. Locator keys and keyways
81. Segmented divider (orifice) plates
82. Orifice formed around central rotating shaft
83. Processing rotor vanes
84. Primary Vortex Disrupter Pins

As such, the above FIGS. 1-15 and Reference Numbers 1-55, 100, and 110 apply to the new PulseWave Quantum Decompiler (QD) apparatus, and the above FIGS. 16-18 and Reference Numbers 56-86 apply to the prior art PulseWave Natural Resonance Disintegration (NRD) apparatus, both of which are characterized below.

In a manner heretofore not possible in any prior art device and as described herein, the PulseWave QD apparatus 1, 100, 110 of the disclosure allows for various configurations that can efficiently reduce the particle size of particular various biological and non-biological materials composed of wet or dry discrete objects into relatively smaller micronic or submicronic particles by flowing the material through a relatively quickly and easily configurable and reconfigurable apparatus having three to six processing chambers 21, each containing processing rotors 22 with or without processing rotor vanes 11 of various configurations, and segmented divider (orifice) plates 18 of various sizes, shapes, relative geometry, and numbers with various sizes of orifices at the centers thereof such as to more efficiently process any given material.

Referring to FIGS. 1A and 1B, a representative PulseWave Quantum Decompiler (QD) apparatus 1 according to implementations thereof may include a vertically-oriented common mounting pillar 13 upon which are mounted an electric drive motor 5 on a hinged mounting plate 19 directly above the PulseWave QD apparatus 1, being joined by a direct drive mill to motor shaft coupler 14 allowing for the apparatus 1 and the electric drive motor 5 to be quickly and easily decoupled for maintenance or repair operations. The apparatus 1 may further include top and bottom machine mounting plates 36 that are also mounted upon the common mounting pillar 13. A feed hopper and chute 27 is positioned in the mill top plate 30 to provide a large area to introduce feed material to be processed into the inlet port 16 in mill top plate 30 for delivery into the inlet chamber 54 of the apparatus whereby the inlet port 16 is in alignment with the top processing rotor 32 while remaining as radially distant from the central rotating shaft 3 as possible. In various implementations, feed hopper and chute 27 may be rectangular, round, oval or another shape and may include a flange for attaching to the mill top plate 30 with threaded fasteners.

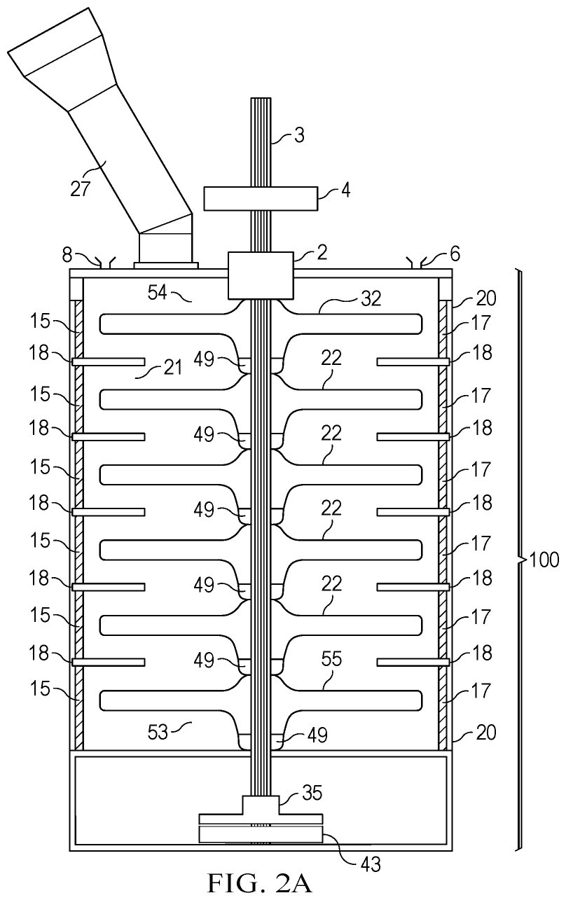

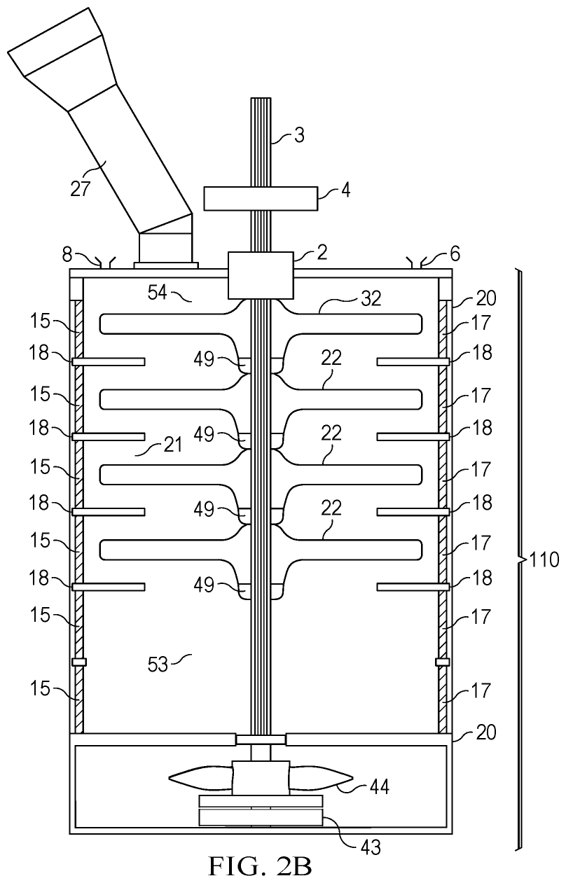

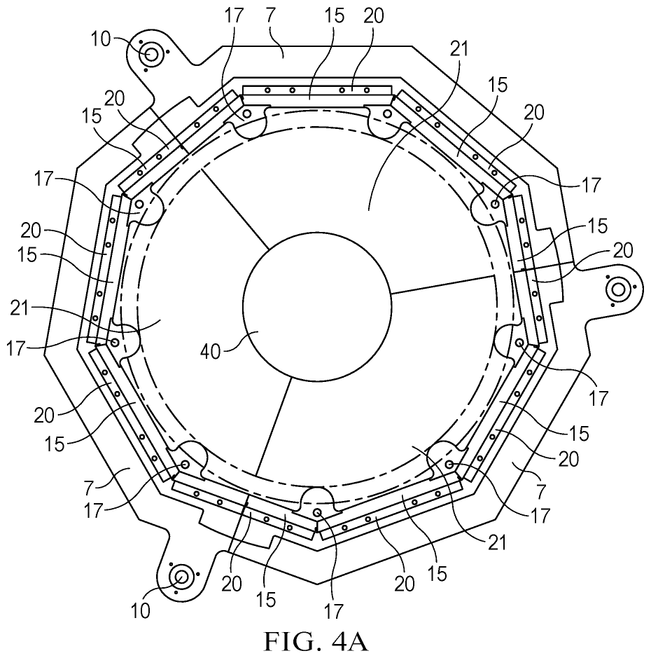

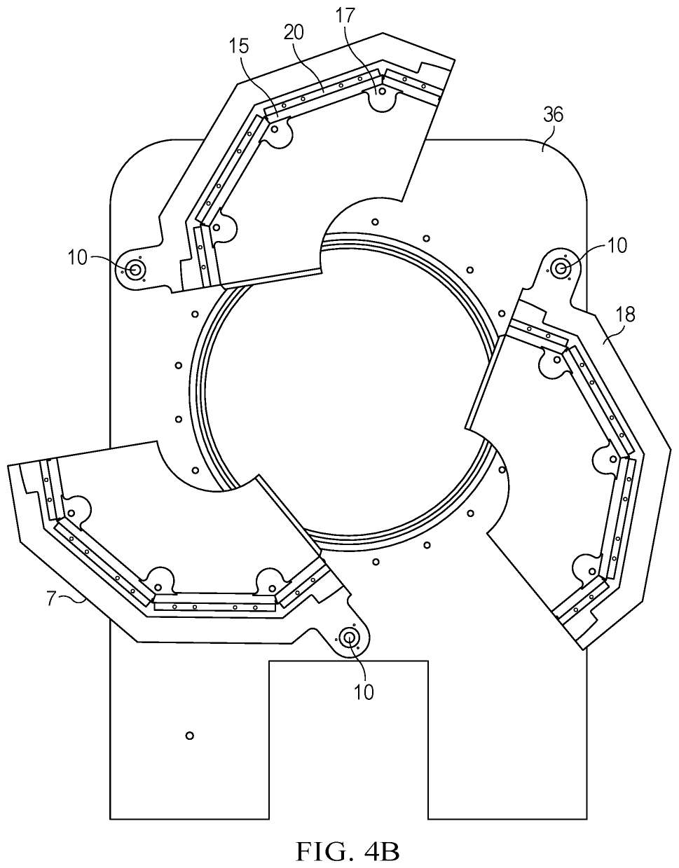

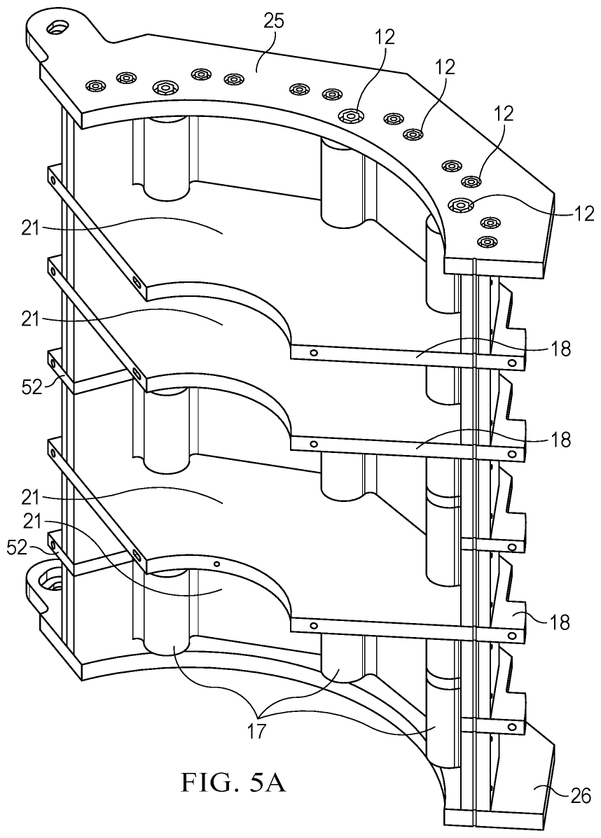

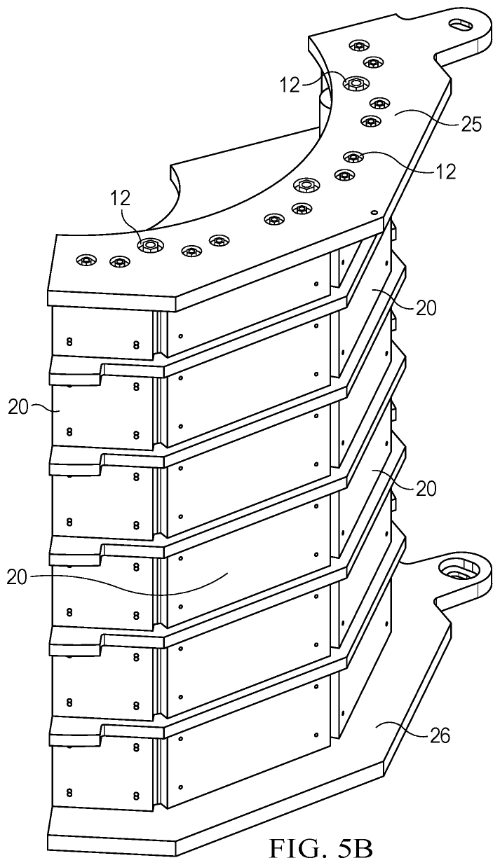

Referring to FIG. 2A, in an implementation, the PulseWave QD apparatus 100 comprises six processing chambers 21. Referring to FIGS. 2B, 5A and 5B, in another implementation, the PulseWave QD apparatus 110 comprises four processing chamber 21. Regardless of the number of processing chambers 21, each apparatus 1, 100, 110 includes certain common features, such as a feed hopper with chute 27, primary fluid injection port 6, and secondary fluid injection port 8 at the mill top plate 30 of the apparatus 1, 100, 110. While the first or topmost processing chamber, sometimes referred to as the inlet chamber 54, and the second processing chamber 21 are in a similar relative position in most implementations of the apparatus 1, 100, 110, the spacings, sizes and placements of the third, fourth, fifth and/or sixth processing chambers may be varied to achieve the desired processing results for a given material. FIG. 4A illustrates a cutaway plan view of an implementation of a processing chamber 21.

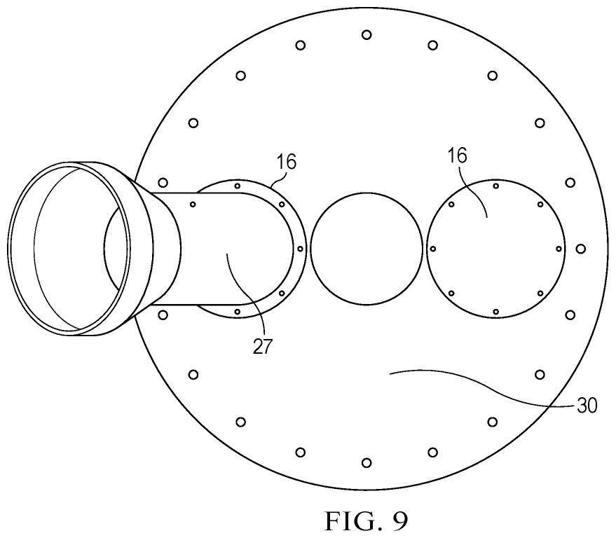

Referring to FIG. 9, the PulseWave QD apparatus 1 may utilize round or oval-shaped feed hoppers and chutes 27 that may be affixed to one or both of the round or oval-shaped inlet ports 16 that may be of a matching or different design. This structure tends to minimize bridging issues in feeding some materials as experienced when using square or rectangular feed chutes and hoppers 27, such as with the PulseWave NRD apparatus.

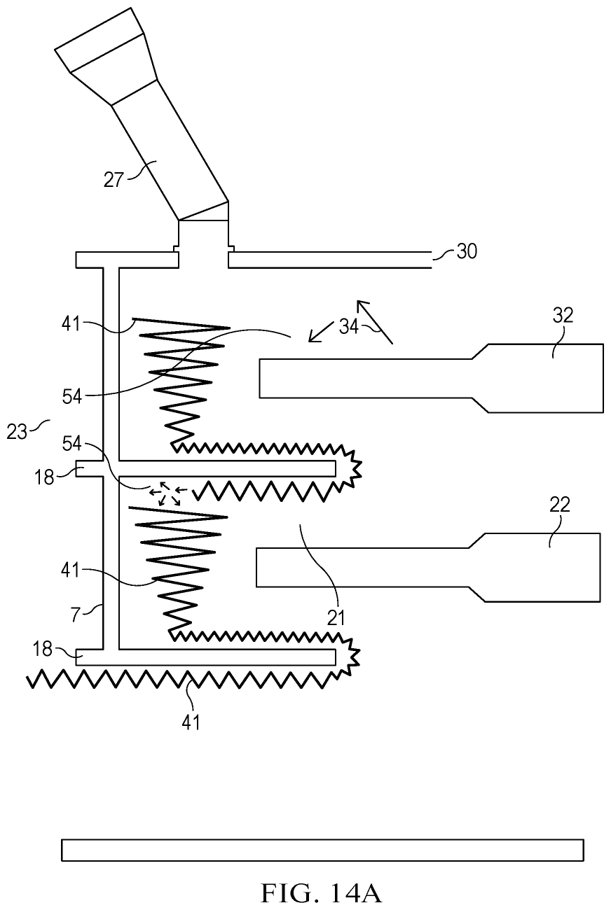

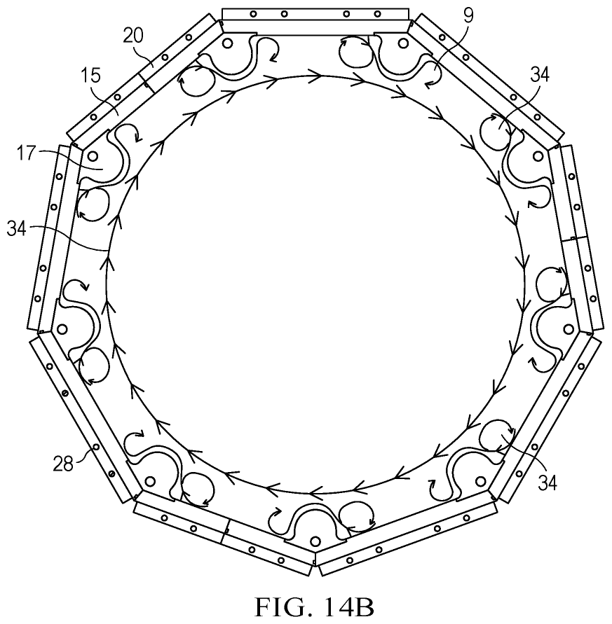

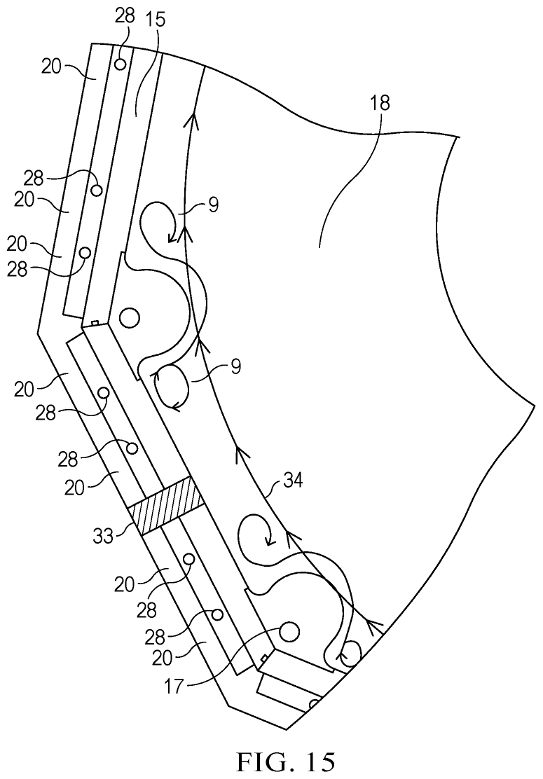

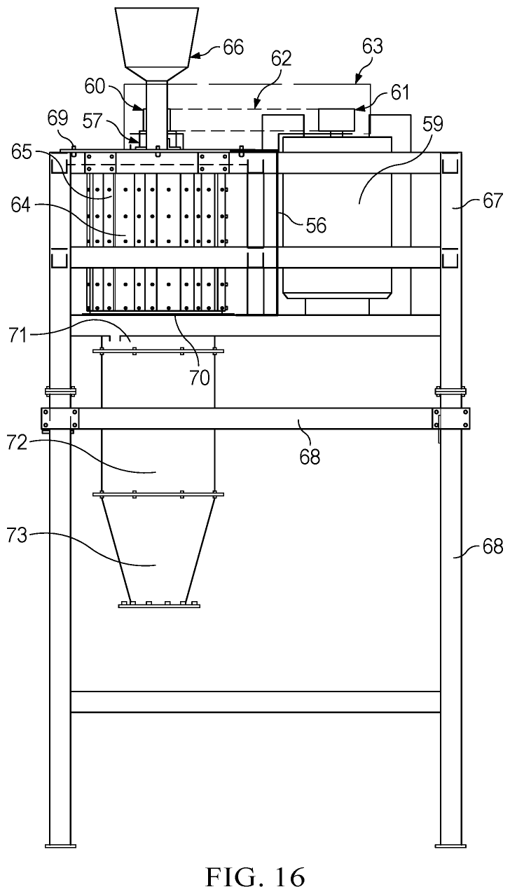

Now referring to FIG. 14A, processing is accomplished by introducing the incoming raw materials 31 into to the feed hopper and tube 27 at the top end of the apparatus such that they can then pass through the inlet port 16 in the mill top plate 30 of the apparatus 1 and into its topmost processing chamber 21, sometimes referred to as the inlet chamber 54, where the material enters the fluid stream 34, which is also depicted in FIG. 14B.

In common implementations of the PulseWave QD apparatus 1, before material is fed into the apparatus, processing rotors 22 are brought up to an operating speed of rotation, inducing generation of a large air flow with negative back pressure through feed hopper and chute 27 into mill inlet chamber 54. Thus, any material fed into feed hopper and chute 27 will be immediately drawn into the apparatus 1 and accelerated rapidly towards distributor rotor 32. At the entry point, the apparatus 1 discharges the material from feed hopper and chute 27 onto distributor rotor 32 at a point radially distant from its central hub toward the outer edge thereof such as to contact the outer portions of the distributor rotor vanes 11.

Material may be broken apart while accelerating down feed hopper and chute 27, or while changing direction when passing through mill top plate 30. It is believed that the mill top plate inlet ports 16 acts as an orifice similar to those orifices 40 formed at the center of the segmented divider plates 18 through which air and the feed-stock material flows into the larger volume region between mill top plate 30 and distributor rotor 32. The flow through this first orifice in the mill top plate 30 can cause a rapid pressure change which may be accompanied by a temperature change. The pressure change, together with the rapid acceleration of the particles exiting feed hopper and chute 27, can cause a first shock compression and/or expansion and an initial breaking apart of some particles within the fluid stream 34, and smaller particles of approximately less than 1 to 1.5 inches (2.5-3.8 cm) in size may be quickly entrained in the Coanda flow 41.

Materials may be delivered into the feed hopper and chute 27 of the PulseWave QD apparatus, which alternatively may be removed for affixing direct conveyances, such as screw type or pneumatic transports and feeders, to the inlet ports 16 of the apparatus for automated product feeding and delivery directly into the top processing chamber 21 of the apparatus, also sometimes referred to as the inlet processing chamber 21, being the first of three to six processing chambers 21 that provide a volume in which materials and fluids may impact each other and blend in a turbulent manner where the mixture is organized into a fluid stream 34 before transitioning into an adjacent processing chamber 21.

Once the material enters the inlet chamber 54 it becomes entrained in a fluid stream 34 within the inlet chamber 54 and is passed into the next lower processing chamber 21 through an orifice 40 formed at the center of the segmented divider (orifice) plates 18 forming the separation between processing chambers 21, said orifice 40 surrounding the central rotating shaft 3 of the apparatus 1. The actions causing movement of the processed materials from one processing chamber 21 to the next within the fluid stream 34 are referred to as the PulseWave QD Forces as further described herein.

Referring to FIGS. 2A, 2B, 4A, and 5A, the processing chambers 21 of the PulseWave QD apparatus 1, 100, 110 and the components contained therein will now be described in detail. The processing of materials occurs within the confines of the various three to six processing chambers 21 of the PulseWave QD apparatus 1, 100, 110 based on the configuration selected to most efficiently process a given material.

Referring again to FIGS. 2A and 2B, the PulseWave QD apparatus 1, 100, 110 of the present disclosure is composed of a topmost or inlet processing chamber 54, a discharge processing chamber 53 and other processing chambers 21 thereinbetween. Each processing chamber 21 contains a splines processing rotor 22 affixed to the splined central rotating shaft 7 for rotation therewith. Implementations of the apparatus can include at least three and as many as six processing rotors 22 within the same number of processing chambers 21, including an topmost or distributor rotor 32 attached to the central rotating shaft 3 and positioned closest to where the material is fed into the inlet ports 16 formed in the mill top plate 30 of the apparatus, a bottommost or discharge rotor 55 also attached to the central rotating shaft 3 and positioned closest to where the material is discharged from the discharge chamber 53 of the apparatus, and other processing rotors 22 are positioned thereinbetween. The uppermost and lowermost boundaries of each processing chamber 21 other than the inlet chamber 54 and discharge chamber 53 are formed by segmented divider plates 18 affixed to the three hinged, removable outer doors 7, the top and bottom of the former chambers being formed by the mill top plate 30 and the mill bottom plate 51, respectively. The outermost boundaries of all processing chambers 21 are defined by the inner surfaces of the same three hinged, removable outer doors 7 that constitute the outermost perimeter of the apparatus.

An implementation of the distributor processing rotor 32 may optionally present a nonagonal-shape with zero, three, or nine straight, curved, or semi-curved processing rotor vanes 11 and/or zero, three, or nine Secondary Battlement Vortex Disrupters 29 in the periphery thereof. In addition to assisting with the generation of a chaotic flow within the fluid stream, the Secondary Battlement Vortex Disrupters 29 serve another purpose as an internal balancing mechanism. The design and depth of the various Secondary Battlement Vortex Disrupters 29 can be manually altered by grinding and removal of additional metal such as to provide for balancing of the processing rotors 22 in which they are formed. Using this process as necessary on each processing rotor throughout the apparatus can result in more quickly and efficiently balancing the entire rotating assembly. This type of balancing is preferred as opposed to welding or otherwise adding weights to the bottom side of processing rotors 22 or to the backside of processing rotor vanes 11 as in the prior art PulseWave NRD apparatus.

In an implementation of the PulseWave QD apparatus, material 23 entering the inlet chamber 54 is directed centrifugally outward by optional processing rotor vanes 25 with enlarged, rounded top edges toward the segmented wear plate assemblies 15 and Primary Vortex Disrupter Pins 17 being affixed thereto and imbedded between the segmented divider plates 18 formed into the hinged, removable outer doors 7 of the apparatus that comprise the outer walls of the processing chambers 21. When the hinged, removable outer doors 7 of the PulseWave QD apparatus 1, 100, 110 are rotated into the closed position, the segmented wear plate assemblies 15 form the outer perimeters of each processing chamber 21 contained therein.

Depending on the configuration of the apparatus 1, 100, 110 from three to six processing chambers 21, the processed material leaving the inlet chamber 54 continues to pass through each of the next two to five successive processing chambers 21 until being discharged from the discharge chamber 53 into the product discharge chute 48 in a continuous fluid flow 34 that takes less than one second from the time of entry into the device until discharge therefrom.

The topmost and bottommost processing chambers 54 and 53, respectively, are defined at their uppermost and lowermost boundaries by the mill top plate 30 and the mill bottom plate 51, and the upper and lower boundaries of the processing chambers 22 that lie thereinbetween are defined by segmented divider (orifice) plates 18 formed in the hinged, removable outer doors 7 of the apparatus 1, 100, 110.

Referring now to FIG. 4A, the inward most boundary of each processing chamber 21 is defined by ⅓ of an orifice 40 that, when the hinged, removable outer doors 7 of the apparatus are rotated closed, join to form a complete circular orifice 40 around the central rotating shaft such as to allow for the passage of materials in the fluid stream 34 from one processing chamber 21 to the next lower processing chamber 21. The outer boundary of the processing chambers 21 are defined by the segmented wear plate assemblies 15 that contain the Primary Vortex Disrupter Pins 17.

Each processing chamber 21 within various implementations of the PulseWave QD apparatus contains a single Type 1, Type 2, or Type 3 processing rotor (45, 46, or 47 respectively) that may be relatively quickly and easily removed and replaced and affixed in various alternative combinations and recombinations whereby the various processing rotors 22 may be offset or not offset from adjacent processing rotors 22.

In an implementation of the PulseWave QD apparatus, the segmented wear plate assemblies 15, and the Primary Vortex Disrupter Pins 17 affixed thereon may be formed into elements sometimes referred to as processing chamber outer wall segments, each of which may be fitted between the segmented divider plates 18 of the device in collectively forming the inner face of the hinged, removable outer doors 7 of the apparatus and the outer walls of the processing chambers 21 of the apparatus, being substituted for and in place of the other named individual components.

The segmented wear plate assemblies 15 are held in place by rods passing through them, the segmented divider plates 18, and the top machine ring 25 and bottom machine ring 26 of the hinged, removable outer doors 7 of the device. The availability of the relatively quickly and easily opened hinged outer doors of the PulseWave QD apparatus offers an unprecedented and unparalleled opportunity to install, uninstall, configure, and reconfigure the number and size of the processing chambers 21 and thus the efficiency of processing a given material.

Referring to FIGS. 1C, 2A, 2B, 4A and 5B, the upper and lower boundaries of all but the topmost and bottommost processing chambers of the PulseWave QD apparatus are individually formed by segmented wear plate assemblies 15 embedded in the hinged, removable outer doors 7 of the apparatus and held in place by retainer plates 20 as illustrated in positioned proximate the segmented divider plates 18 and by retainer rods 12 extending through openings therein for the purpose of securing them into position. The segmented wear plate assemblies 15 in some implementations may have the dimensions of approximately 4½ inches high, extending the entire radius of the hinged, removable outer door 7 segments, and may be formed of hardened 17-4 pH stainless steel. Retainer plates 20 may have the dimensions of approximately 4¼ inch high and 9 inches long, and may be formed of 304 stainless steel. The retainer plates 20 are positioned to secure segmented wear plate assemblies 15 into position. Retainer rods 12 pass through retainer rod apertures 28 in segmented wear plate assemblies 15 and the segmented divider plates 18 to further secure them into position.

The outer periphery of each processing chamber 21 of a PulseWave QD apparatus is defined by three segmented wear plate assemblies 15 upon each of which are affixed three equally-spaced Primary Vortex Disrupter Pins 17 formed between segmented divider (orifice) plates 18, being constituent components of the three hinged, removable doors 7 which, when rotated into the closed position, collectively form the outer walls of the processing chambers 21. Because the segmented wear plate assemblies 15 that are formed in each of the three hinged, removable outer doors 7 of the apparatus contain three Primary Vortex Disrupter Pins 17, there are therefore nine Primary Vortex Disrupter Pins in each processing chamber 21.

Implementations of the PulseWave QD apparatus may include three to six processing chambers 21 with a plurality of three to six processing rotors 22 with hubs containing involute splines 37 for central coupling to the splined central rotating shaft 3 for rotation therewith, all longitudinally spaced apart therein. The processing rotor 22 may be round or with an approximately polygonal-shaped peripheral edge having apices, and a plurality of zero, three, or nine straight or curved processing rotor vanes 11, each extending approximately radially inward from one of the apices to the hub.

Splined shaft spacers 49 are positioned between adjacent pairs of processing rotors 22 and adjacent mill top plate 30 and mill bottom plate 51, respectively. The longitudinal position of one or more than one of the processing rotors 22 can be adjusted by changing the length one or more of splined shaft spacers 49 and installing a matching set of hinged, removable outer doors 7.

A topmost processing rotor 22, being referred to as the distributor rotor 32, is positioned closest to the mill top plate 30 such that material introduced into the apparatus 1 through one or more feed hoppers and chutes 27 is directed toward the distributor rotor 32. An segmented divider plate 18 with an orifice is positioned between each pair of adjacently located processing rotors 22. Each segmented divider plate 18 extends inwardly from the internal sides of the three hinged, removable outer doors 7 of the apparatus to a central aperture which provides an orifice around the central rotating shaft 3.

Segmented divider (orifice) plates 18 are positioned between adjacent pairs of processing rotors 22 and extend inwardly from the hinged, removable outer doors of the PulseWave QD apparatus. Each segmented divider plate 18 includes a segment of a central aperture which, when the hinged, removable outer doors 7 of the apparatus are rotated into the closed position, form an annular shaped orifice 40.

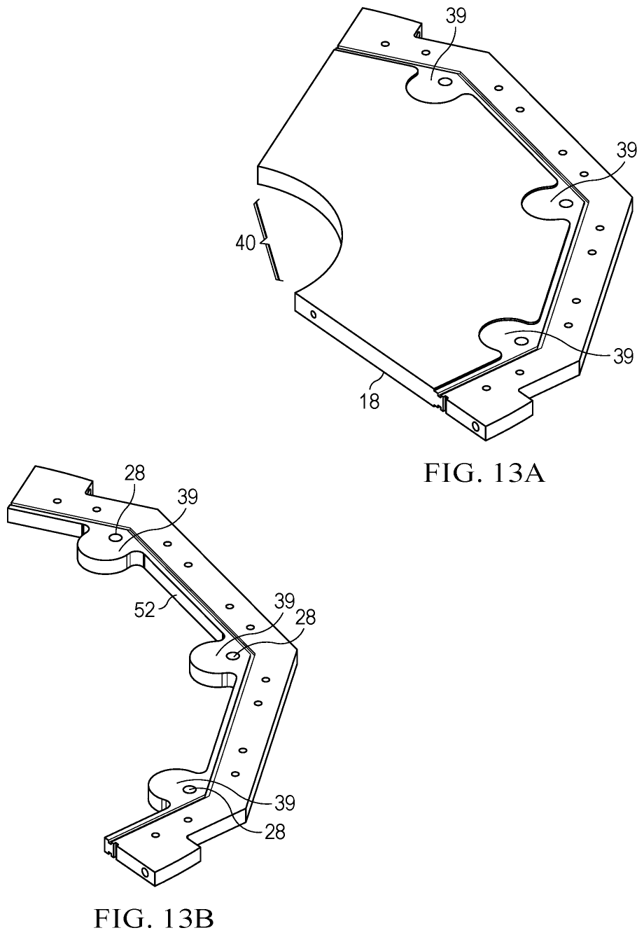

Referring to FIGS. 13A, 13B, and 15, in certain implementations of the PulseWave QD apparatus in which less than six processing chambers 21 are preferred, a segmented divider plate spacer 52 may be inserted in place of a segmented divider plate 18 as a substitute therefor such as to accommodate the elimination of the segmented divider plate 18 that constitutes the upper or lower boundary of any particular processing chamber 21 after the inlet processing chamber 54.

Referring to FIGS. 2B, 5A, and 5B, the use of segmented divider plate spacers 52 can be seen in a four-chambered implementation of the apparatus. The number and position of substitutions of segmented divider plate spacers 52 can thus be instrumental in defining the number and size of the resulting processing chambers 21.

In implementations of the PulseWave QD apparatus, a discharge chamber 53 is the final processing chamber 21 and contains a round or nonagonal-shaped processing rotor 22 optionally fitted with zero, three or nine straight or curved processing rotor vanes 11, and is sometimes referred to as the discharge rotor 55. A common implementation of the discharge rotor 55 is nonagonal in design and is fitted with nine straight processing rotor vanes 11 that originate at its central hub and terminate at its circumference, the height of the processing rotor vanes 11 of the discharge rotor 55 being greater than that of the other processing rotor vanes 11. The discharge rotor 55 causes the processed material contained in the fluid stream 34 to finally be passed from the discharge chamber 53 downwardly into the product discharge chute 48 for removal from the device.

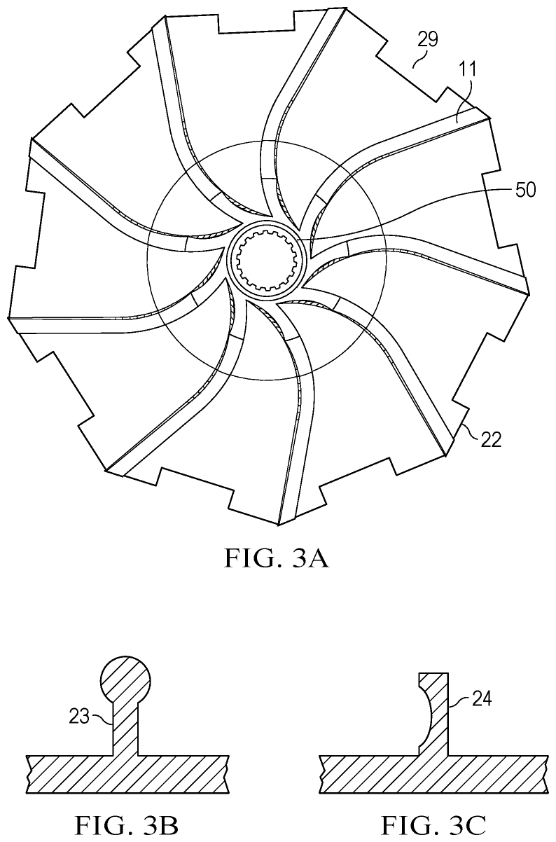

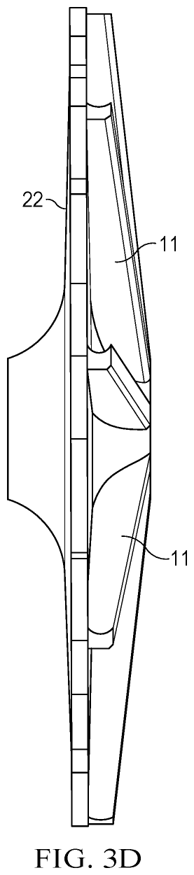

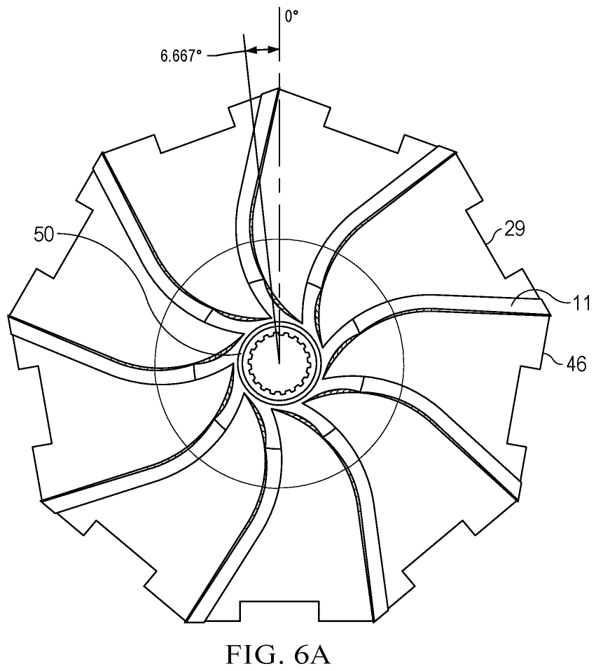

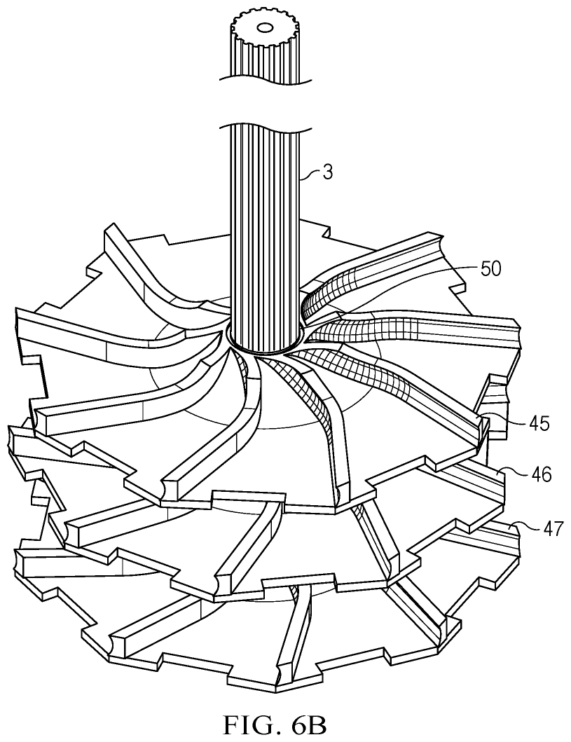

Referring now to FIGS. 3A, 3B, 3C, 3D, 6A and 6B, the processing rotors 22 will be described in detail. The splined processing rotors 22 are affixed to splined central rotating shaft 3 that extends longitudinally through the PulseWave QD apparatus 1 through a top housing 2 that is bolted to mill top plate 30 on the top end and into bottom bearing assembly that may consist of optional splined air bearing platen 35 and low friction air bearings 43 on the bottom end.

In order to prevent the introduction of small particles into the hubs of splined processing rotors 22, splined shaft spacers 49, splined air bearing platens 35, and splined internal mill discharge aspirators 44, thus potentially acting as a hindrance to easily sliding those components onto and off the central rotating shaft 3 of the apparatus for servicing or reconfigurations, O-ring grooves 50 are formed into analogous surfaces of all the hubs thereof to support the insertion of O-rings therein. An O-ring is a ring of pliable material, as rubber or neoprene, used as a gasket or seal between mating surfaces. Thus, O-rings inserted into the grooves of the various hubs that mate precisely to one another act as an effective barrier in preventing processed materials from migrating from the processing chambers 21 to spaces between the central rotating shaft 3 of the apparatus and splines components fitted thereunto.

Referring now also to FIGS. 2A and 2B, the topmost processing rotor 32, which may also be referred to as a distributor rotor 32, is positioned closest to where material is fed into mill top plate 30 via feed hopper and chute 27. Distributor rotor 32 may have a regular pentagonal, heptagonal, or nonagonal-shaped peripheral edge forming its apices, or outside corners.

Referring further to FIG. 6, an implementation of a common processing rotor 22 will be described. Processing rotor 22 includes a central hub with 18 splines 37 having a regular nine-sided polygonal peripheral edge forming nine apical corners. The processing rotor 22 is either cast or machined as one piece together with the splined central hub 37 thereof, or welded or otherwise rigidly coupled thereto with fasteners. Processing rotor 22 in this implementation includes nine semi-curved processing rotor vanes 11, each extending approximately radially inward toward the hub from the respective apical corners with the curves thereof facing in the direction in which the processing rotor 22 turns, generally in a clockwise rotation. Outer trailing edges of processing rotor vanes 11 can be beveled at an angle to align with the peripheral edge of the processing rotor 22 such that there is no overlap between processing rotor 22 and processing rotor vane 11, or so that trailing edge of the processing rotor vane 11 extends slightly over outer edge of the trailing side of an apical corner of the processing rotor 22.

In a common implementation of the PulseWave QD apparatus, all processing rotors 22 may, for example, be configured similarly, each having a nine-sided peripheral edge and curved or semi-curved processing rotor vanes 11 extending radially inward from apical corners of the processing rotors 22 to the hubs thereof.

Each circular or substantially polygonal-shaped processing rotor 22 of the PulseWave QD apparatus is available in three optional iterations which may be affixed to the central rotating shaft 3 for rotation therewith in multiple configurations, being Type 1 45, Type 2 46, and Type 3 47 processing rotors, so named depending on the rotational offset of each. The central rotating shaft 3 contains 18 involute splines that extend the length thereof, or nearly so, in alternate configurations, and each of the three types of processing rotors 22 include hubs with 18 matching involute splines within the inside circumference thereof. Each of the three types of processing rotors 22 are offset from the other by exactly one third of a spline, representing approximately 6⅔ degrees of rotation. Each circular or substantially polygonal-shaped processing rotor 22 of any of the three types may have zero, three, or nine Secondary Battlement Vortex Disrupters 29 cast, forged, or machined into the peripheral edges at the centroids thereof. Similarly, a plurality of zero, three or nine processing rotor vanes 11 may optionally originate and extend approximately radially inward to the central hub thereof in a straight, curved, or semi-curved shape from the outer periphery at an apex thereof, not necessarily in alignment with the same sides as contain Secondary Battlement Vortex Disrupters 29.

In common implementations of the PulseWave QD apparatus 1, processing rotor vanes 11 that extend approximately radially inward from the outer edges of the processing rotor 22 may extend upward from the top side of the processing rotors 22 toward mill top plate 30, but alternate implementations may include processing rotor vanes 11 that extend downwards from the bottom side of the processing rotors 11 and away from mill top plate 30, or alternatively may include processing rotor vanes 11 that extend upwards and downwards from the top side and bottom side of the processing rotors 11.

The topmost and bottommost parameters of each processing chamber 21 in the PulseWave QD apparatus 1 are formed by segmented divider (orifice) plates 18 that are separated by nine equally-spaced Primary Vortex Disrupter Pins 17 of various lengths defining the height and thus the volume of each processing chamber 21 and providing for different spacings between the processing rotors 22 and the segmented divider plates 18. The Vortex Disrupter Pins 17 located in each of the processing chambers 21 define the height of the processing chambers 21 and add structural integrity to the device while encouraging generation of a chaotic, or turbulent fluid stream within the apparatus 1

One, two, or all three of the hinged, removable outer doors 7 constituting the outer perimeters of the processing chambers 21 may be quickly and easily rotated open or closed at any one time for internal inspection of or repairs of the apparatus 1.

Each processing rotor vane 11 is positioned such that when the processing rotor 22 is spinning, a trailing outer edge of each processing rotor vane 11 is approximately aligned with the peripheral edge of the processing rotor 22 at an apex thereof, or extending slightly over the outer edge thereof, depending on the desired configuration thereof for more efficiently processing a given material.

Processing rotor vanes 11 can be cast into the processing rotors 22 or affixed by welding or fitted into corresponding slots formed therefor and attached with fasteners the preferred implementation being casting processing rotors 22 and processing rotor vanes 11 as a single component. Alternatively, each distributor rotor vane 11 can fit into corresponding slots formed in the surface of processing rotors 22 and secured by threaded fasteners that screw into corresponding threaded holes in processing rotor vanes 11.

Common implementations of splined processing rotors 22, splined shaft spacers 49, splined air bearing platens 35, and the hubs of splined harmonic balancers 4 and splined internal mill discharge aspirators 44 in the described disclosures of the apparatus may be cast, forged, or machined from different materials, including harder materials, such as for example hardened 17-4 pH stainless steel, and softer materials, such as for example 1020 steel, depending upon the intended application for the apparatus, and the processing rotors 22 may vary in thicknesses generally ranging in the vicinity of one half inch or more or less, and may be of varying diameters generally ranging from approximately 15 inches to approximately 21 inches and may be upscaled or downscaled for various applications.

As briefly described (see Detailed Description of the PulseWave QD apparatus 1), the vertical stack of three to six processing rotors 22 mounted on a splined central rotating shaft 3 are separated by segmented divider (orifice) plates 18. Thus, a series of processing rotors 22 are present in the overall nonagonal-shaped processing chambers 21 of the apparatus. These processing chambers 21, being vertically adjacent to one another, provide for a continuous movement of material in the fluid flow through orifices formed at the center of the segmented divider plates 18 embedded in the three hinged, removable outer doors 7 of the apparatus and surrounding the central rotating shaft 3.

The integrated design of both the processing rotors 22 and the processing chambers 21 of the PulseWave QD apparatus is such that these shock waves occurring in a given processing chamber 21 are out of phase with one another, yet are occurring at the same or different frequencies, depending upon the configuration of the components contained therein. This phasing consideration is an important and essential design feature. If the entire process were in phase, huge amounts of destructive energy would be transferred to the machine itself rather than being transferred to the material being processed.

The PulseWave QD apparatus 1, 100, 110 provides substantial surface area of its processing rotors 22 compared to the outer width dimensions. This allows for substantially increased processing capabilities relative to the physical size of the apparatus.

Referring to FIG. 6B, one can see that implementations of the PulseWave QD apparatus 1 may contain any one or a variety of the three optional types of processing rotors 22 which are rotationally offset one from the other by ⅓ of a spline, being 6⅔ degrees of clockwise or counterclockwise rotation. An example implementation of offset processing rotors 22 using the three types thereof are illustrated in, being Type 1, Type 2, and Type 3 processing rotors (45, 46 and 47, respectively) in a preferred counterclockwise offset. Type 1 processing rotors 45 have no offset to the basic alignment with the splines of central rotating shaft 3 of the apparatus. However, each Type 2 processing rotor 46 is offset from Type 1 processing rotors 45 in a counter-clockwise direction by one third of a spline, being equivalent to 6⅔ degrees of rotation, and each Type 3 processing rotor 47 is further offset in a counter-clockwise by ⅓ spline from each Type 2 processing rotor 46, being ⅔ spline offset from each Type 1 processing rotor 45, meaning that Type 2 processing rotors 46 are offset clockwise or counterclockwise from Type 1 and Type 3 processing rotors 45 and 47, respectively, by 6⅔ degrees of rotation, respectively, and each Type 3 processing rotor 47 is offset in a counterclockwise rotation from each Type 2 processing rotor 46 by 6⅔ degrees and offset by 13¼ degrees of counterclockwise rotation from each Type 1 processing rotor 45. Thus, as can be seen in FIG. 6B, the three processing rotors 22 are offset from one another by 6% of counterclockwise rotation.

Referring to FIG. 6A, each splined Type 1, Type 2 and/or Type 3 processing rotors 22 may be further configured in an offset arrangement one from the other in an alternating clockwise and/or counterclockwise fashion from its nearest processing rotor in increments representing an angular advance or retardation of 6⅔, 13¼, 20, 26⅔, or 33⅓ degrees of rotation from the next closest processing rotor in uniquely selective increments determined simply by the placement of the respective types of processing rotors 22 onto the splined central rotating shaft 3 in a preferred array. FIG. 6A illustrates a plan view of one implementation of a Type 2 46 processing rotor 22 offset by ¼ spline representing 6⅔ degrees of rotational offset from a Type 1 45 processing rotor 22.

In common implementations of the PulseWave QD apparatus 1, each Type 1, Type 2 and/or Type 3 splined processing rotor 22 have diameters of approximately 21 inches and are nonagonal-shaped, although processing rotors 22 may be of other polygonal or round dimensions in alternate implementations, and each processing rotor 22 contains nine processing rotor vanes 11, while they may alternatively may contain zero or three processing rotor vanes 11.

Each Type 1 45, Type 2 46 and/or Type 3 47 splined processing rotor 22 in implementations of the PulseWave QD apparatus may be cast, forged or machined to include three, or nine Secondary Battlement Vortex Disrupters equally spaced within its outer perimeter, each being in the shape of a rectangle with squared corners, a rectangle with radiused corners, a half-octagon, a semi-circular or otherwise for the purpose of more efficiently processing certain materials by causing additional swirling and disruptions in the fluid stream, thus increasing the chaotic flow therein resulting in increased particle-to-particle collisions that may enhance a gentle but highly-effective comminution, while those same processing rotors may similarly be cast, forged or machined to include zero Secondary Battlement Vortex Disrupters within their outer perimeter for the purpose of increasing the laminar flow within the fluid stream and thus increasing machine-to-particle collisions that may increase efficiency in a more robust comminution when processing certain other materials not requiring a gentler process.

Referring to FIGS. 2A and 2B, a 6-chamber design and a 4-chamber design, respectively, are illustrated. In the former are six longitudinally spaced processing chambers 21 containing processing rotors 22, each being coupled to the central rotating shaft 3 by the sliding thereof upon matching sets of involute splines 37. Splined shaft spacers 49 are positioned between adjacent pairs of processing rotors 22 and are positioned adjacent to the distributor rotor 32 and the mill top plate 30 and the discharge rotor 55 and the mill bottom plate 51, respectively. In the latter example, the same formation is applied except for the removal of two processing chambers 21 to comprise a four chamber implementation of the apparatus 1.

In common implementations of the apparatus 1, the diameter of each splined shaft spacer 49 is approximately 3.5 inches in matching the diameter of the hubs of the processing rotors 22. The longitudinal position of one or more than one processing rotors 22 can be relatively quickly and easily adjusted by changing the length of one or more of shaft spacers 49 in conjunction with affixing matching hinged, removable outer doors 7 of the apparatus 1 in forming processing chambers 21 of various dimensions.

Processing rotors 22 in implementations of the PulseWave QD apparatus can optionally be fitted with processing rotor vanes 11 formed on their bottommost surface in addition to the processing rotor vanes 11 formed on the topmost surface.

Referring now to FIGS. 3B and 3C, cross-section views of two implementations of processing rotor vanes 11 that originate at the central hub of processing rotor 22 and radiate in a straight line to the outer circumference thereof are illustrated. The contour of processing rotor vane 23 incorporates an enlarged, annular top edge and flat sides, while the contour of processing rotor vane 24 incorporates a flat top edge and a concave side in the clockwise direction of rotation.

Optional implementations of the PulseWave QD apparatus include straight, curved, or semi-curved processing rotor vanes 11, each of which may reflect a greater height at the point where they emanate from the processing rotor hub as compared to the height nearest the apices of the processing rotor outer edges. The optional increased vane height at the hub end and sometimes combined with a concave shape on the leading edge in some implementations will tend to allow less material to flow over the top of the processing rotor vanes 11 and thereby move a greater concentration of the material flow to the outer edge of the processing rotor where it becomes entrained in the material flow in the fluid stream 34. Processing rotor vanes 23 may also be designed with a larger, rounded top for additional durability. Such irregular shapes also tend to enhance a more chaotic flow of material within a fluid stream.

Implementations of the PulseWave QD apparatus include segmented wear plate assemblies 15 forming the outer walls of each processing chamber 21 of the PulseWave QD apparatus 1 that are further secured by retainer rods 12 passing through them, through the segmented divider plates 18, and through the segmented top machine rings 25 and segmented bottom machine rings 26 of the hinged, removable outer doors 7 of the device.

FIG. 1C illustrates a side view of the PulseWave QD apparatus showing hinged, removable outer doors 7 that form processing chambers 21 having been rotated into the open position on hinge pins 10 held in position by the top and bottom machine mounting plates 36. In each processing chamber 21, segmented divider (orifice) plates 18 are affixed to the hinged, removable outer doors 7 for rotating open and closed in concert therewith.

Referring now to FIGS. 1C, 2A, 2B, 5A, 13A and 15, segmented divider (orifice) plates 18 are positioned between adjacent pairs of processing rotors 22 extending from the inward most sides of the hinged, removable outer doors 7 of the apparatus to surround the central rotating shaft 3 thereof such that when the hinged, removable outer doors 7 are rotated into the closed position, they form the upper, lower, and outermost boundaries of the various processing chambers 21. Each of segmented divider (orifice) plates 18 includes a portion of a central aperture at the innermost point thereof, which, when the hinged, removable outer doors 7 are rotated into the closed position provides an annular shaped orifice 40 around the central rotating shaft 3 in each processing chamber 21.

In each nonagonal-shaped processing chamber 21 of implementations of the PulseWave QD apparatus 1 containing nonagonal-shaped processing rotors 22, there would be nine Primary Vortex Disrupter Pins 17 in the outer walls thereof. The material flow within the fluid stream 34 is thus forced outward by the processing rotors 22 such that the fluid encounters these Primary Vortex Disrupter Pins 17, which, due to their shape and location, cause material particles to swirl back against the main fluid flow and collide with other particles within the fluid stream. These disruptions of the fluid stream may be further enhanced by addition of optional Secondary Battlement Vortex Disrupters 29 in the outer edges of certain processing rotors 22, all of which pass in close proximity to the Primary Vortex Disrupter Pins 17 in multiplying the effects thereof.

In various implementations of the PulseWave QD apparatus, Secondary Battlement Vortex Disrupters 29 may be optionally offset to the convex side of processing rotor vanes 11 or centered within the outer edges thereof.

Referring to FIGS. 1B, 1C, and 4B, any one, two, or all three hinged removable outer doors 7 of the PulseWave QD apparatus 1 may be relatively quickly and easily opened at any time for inspection, cleaning or maintenance. Now referring to FIGS. 1B, 1C, 2A, 2B, and 9, this design allows for removal of the mill top plate 30 of the device after which the entire central rotating shaft 3 with affixed processing rotors 22 as illustrated in FIGS. 2A, 2B, and 6B may be relatively quickly and easily removed through the top of the apparatus after removing the mill top plate 30 and is relatively quickly and easily replaced thereafter.

Referring to FIGS. 1B, 1C and 4B, top and bottom machine mounting plates 36 extend outward beyond the segmented divider plates 18, segmented wear plate assemblies 15, and the retainer plates 20 such that the apparatus 1 can be affixed to the common mounting pillar 13.

Referring again to FIG. 14B, a plurality of Primary Vortex Disrupter Pins 17 are arranged such as to provide additional stability to the processing chambers 22 while inducing vortexes in the fluid stream of materials 34 opposite to the main flow of the material in order to induce a more chaotic flow within the fluid stream, each of the segmented wear plate assemblies 15 comprising portions of the outer walls of the various processing chambers 21 formed within in each of the three hinged, removable outer doors 7 of the PulseWave QD apparatus 1, and which when rotated into the closed position collectively form the complete outer perimeters of each processing chamber 21 contained therein.

The flow of materials within various implementations of the PulseWave QD apparatus 1 is retained within the Coanda flow 41, resulting in minimal contact with the apparatus inner surfaces and thus resulting in reduced wear to the apparatus. The Coanda flow 41 is the tendency of a fluid stream to stay attached to an adjacent curved surface. A free stream of air entrains molecules of air from its immediate surroundings causing an axisymmetric “tube” or “sleeve” of low pressure around the stream. The resultant forces from this low-pressure tube end up balancing any perpendicular flow instability, which stabilizes the stream in a straight line. However, if a solid surface is placed close, and approximately parallel to the stream, then the entrainment (and therefore removal) of air from between the solid surface and the stream causes a reduction in air pressure on that side of the stream that cannot be balanced as rapidly as the low-pressure region on the “open” side of the stream. The pressure difference across the stream causes the stream to deviate towards the nearby surface, and then to adhere to it. The stream adheres even better to curved surfaces, because each (infinitesimally small) incremental change in direction of the surface brings about the effects described for the initial bending of the stream towards the surface.

If the surface is not too sharply curved, the stream can, under the right circumstances, adhere to the surface even after flowing 180° round a cylindrically curved surface such as the processing rotors 22 within the apparatus 1, and thus travel in a direction opposite to its initial direction. The forces that cause these changes in the direction of flow of the stream cause an equal and opposite force on the surface along which the stream flows. These Coanda flow-induced forces are contributory to the PulseWave QD Forces as described herein.

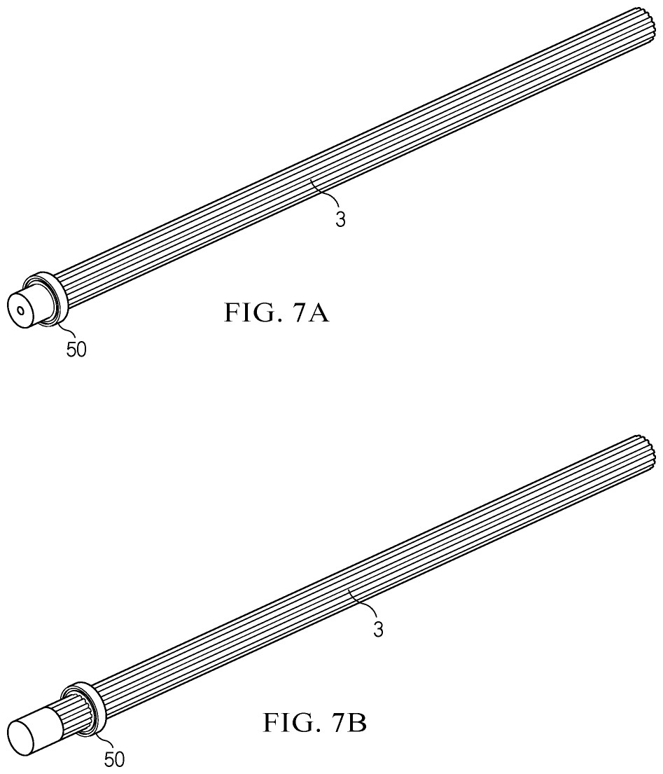

Referring now to FIGS. 2A, 2B, 7A, and 7B, the splined central rotating shaft 3 of the PulseWave QD apparatus is a rotatable shaft with 18 equally-spaced external involute splines that extend substantially along the vertical axis of the apparatus to above the mill top plate 30 and below the mill bottom plate 51. The splines of central rotating shaft 3 integrate with the splines of the central hubs of processing rotors 22, splined shaft spacers 49, splined air bearing platens 35, splined internal mill discharge aspirators 44, and splined harmonic balancers 4 for ease of introduction and removal thereof.

In an implementation of the PulseWave QD apparatus 1, the splined central rotating shaft 3 may be of various dimensions, including such as in one implementation being approximately 661/2 inches long and approximately 2% inches in diameter, with 18 equally spaced involute splines extending from the top end to the bottom end thereof when employing a standard lower thrust bearing, or a splined central rotating shaft 3 containing a bottom end extending approximately 2.75 inches with no splines if in conjunction with a low friction air bearing for lower thrust support. The dimensions of the central rotating shaft 3 and other components of the PulseWave QD apparatus may be increased or decreased in various implementations pursuant to upscaled or downscaled versions thereof, or to meet any specific needs or preferences in processing a given material.

Referring again to FIG. 2A the splined central rotating shaft 3 of the PulseWave QD apparatus 1 may extend below the mill bottom plate 51 and may be optionally fitted with standard design lower roller bearings for the purpose of stabilizing its bottom end with the bottom bearing acting as a thrust support bearing, or can be optionally fitted with a low friction air bearing 43 at bottom also acting as a thrust support bearing.

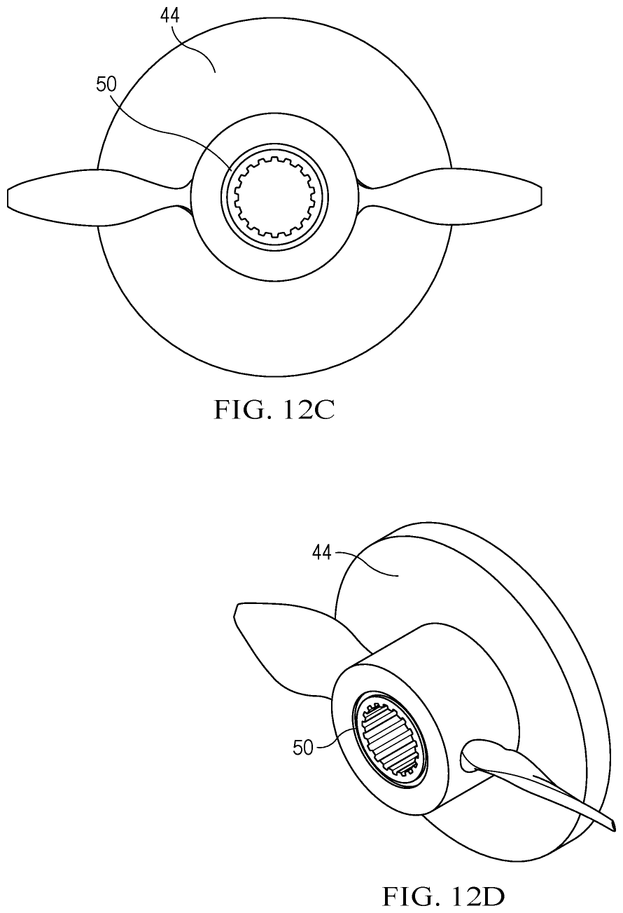

Referring to FIGS. 2A and 12A, and 12B, one will note that when optional lower thrust air bearing 43 is utilized, an optional air bearing platen 35 is fitted to the bottom of the central rotating shaft 3 for mating with the low friction air bearing 43 and may include an additional horizontal stability air bearing above the lower thrust bearing 43 for the purpose of providing additional lateral support to the central rotating shaft 3.

Referring to FIGS. 2B, 12C, and 12D, one will note that an optional air bearing platen 35 may be fitted to the bottom of the central rotating shaft 3 for mating with the low friction air bearing 43 in place of the air bearing platen 35.

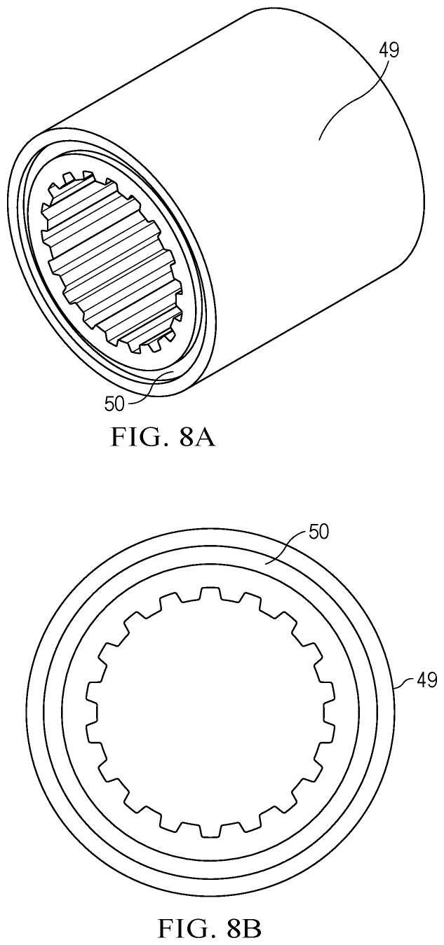

Referring to FIGS. 8A and 8B, implementations of the PulseWave QD apparatus 1 may include splined shaft spacers 49 of various lengths that determine the position of and spacing between processing rotors 22 as also illustrated in FIGS. 8A and 8B. The topmost splined shaft spacer 49 is placed between the inside of the mill top plate 30 and the hub of the topmost, or distributor rotor 32, while the last shaft spacer 49 is placed between the inside of the mill bottom plate 51 and the hub of the bottommost, or discharge rotor 55. Other shaft spacers 49 are positioned between each of the remaining processing rotors 22.

In implementations of the PulseWave QD apparatus, the central rotating shaft 3 extending externally above the top plate 30 of the apparatus may be fitted with an optional harmonic balancer 4 fitted upon a splined hub, the harmonic balancer 4 also acting as an optional balancing ring for external balancing adjustments of the rotating components of the apparatus 1.

Referring to FIGS. 2A and 2B, one or more optional primary and secondary fluid injection ports 6 and 8, respectively, of the PulseWave QD apparatus 1 can be formed at the top of the apparatus such that gasses or fluids may be gravity fed or injected under pressure directly into the topmost or inlet processing chamber 54, including through a regulator. The gas can be additional air, nitrogen, carbon dioxide, or other product, including a chain-reaction producing material to enhance a chemical transformation of the material being comminuted to speed, slow, or stop the reaction or inhibit a chemical transformation of the material being processed. Implementations of the apparatus can further include a heat exchanger on the outside walls thereof configured to provide or remove heat from the outer perimeter of the device.

The various implementations of the PulseWave QD apparatus 1, 100, 110 of the present disclosure can be relatively quickly and easily configured to most efficiently process a given material by selecting:
six, five, four or three processing chambers 21 and thus the number of processing rotors 22, one processing rotor 22 being contained within each processing chamber 21;
the diameter of each of the processing rotors 22 individually;
the shape of processing rotors 22 as round or polygonal dimensions;
the rotational orientation of each processing rotor 22 in an alternating clockwise and/or counterclockwise fashion from its next nearest processing rotor in uniquely selective increments representing an angular advance or retardation of 6⅔, 13¼, 20, 26⅔, or 33⅓ degrees of rotation as determined simply by the placement of the Type 1 45, Type 2 46 and Type 3 47 processing rotors 22 onto the splined central rotating shaft 3 in a preferred array;
the distance between processing rotors 22 using splined shaft spacers 49;
the distance of the segmented divider (orifice) plates 18 from the processing rotors 22 by insertion thereinbetween of Primary Vortex Disrupter Pins 17 of various heights in determining the dimension and therefore the volume of each processing chamber 21 as configured within the hinged, removable outer doors 7;
the number and shape of the processing rotor vanes 11 formed upon each processing rotor 22 as zero, three, or nine thereof, whether straight, curved, or semi-curved in design, and other optional designs, including by way of examples, sloping upwards from an elevation of about 1 inch near the hub of the processing rotor 22 to an elevation of approximately 1½ inches near the outer periphery of processing rotor 22, incorporation of an enlarged, annular top edge and flat sides 23, or incorporation of a flat top edge and a concave side in the clockwise direction of rotation 24.
the inclusion of Secondary Battlement Vortex Disrupters on zero, three or nine outer edges of a nonagonal-shaped processing rotor 22;
splined harmonic balancer 4;
low friction air bearings 43 with optional lower air bearing platen 35;
low friction air bearings 43 with optional internal mill discharge aspirator 44;
Quantum Vortex Turbulator System; and,
other optional features.
   all of which interchangeable and configurable components can be prefabricated and available for making selective configurations or reconfigurations to the PulseWave QD apparatus 1, 100, 110 relatively quickly and easily at any time and on short notice.

Referring to FIGS. 16, 17, and 18, the prior PulseWave NRD apparatus 56 will now be reviewed in lesser detail, while sometimes referring to comparisons with the new PulseWave QD apparatus 1.

The prior art PulseWave Natural Resonance Disintegration (NRD) apparatus 56 as described herein is characterized in U.S. Pat. Nos. 6,135,370; 6,227,473; 6,405,948; China Patent 264004; European Patents 1214150 and 1015120; Australia Patent 752347; Brazil Patent P19811510; Israel Patent 134070; New Zealand Patent 514770; Poland Patent 192546; and South Africa Patent 0.015389447 and the disclosure of each of these patents is incorporated herein by reference.

Both the PulseWave NRD apparatus 1 and the PulseWave QD apparatus 56 are continuous flow machines with precision-balanced components smoothly rotating within their processing chambers as opposed to kinetic energy impact-based milling devices that impart severe, destructive, mechanical impact forces. Because of these and other factors, the apparatuses are relatively quiet and free of vibration. Therefore, compared with impact-based comminution machines, work done in the present apparatuses is considerably greater and more efficient per unit of energy expenditure and performed without imparting damage to the processed materials. Implementations of both PulseWave apparatuses are scalable to larger and smaller sizes.

The prior art PulseWave NRD apparatus 56 is largely fixed in design, allowing for only a limited number of components to be configured or reconfigured, any such reconfigurations being performed at relatively great expense of time and effort, thus being expensive by comparison to the uniquely configurable PulseWave QD apparatus 1 of the disclosure. For example, both apparatuses can be configured with as few as three of as many as six processing chambers as follows:

Reconfiguring the number of processing chambers in the prior art PulseWave NRD apparatus 56 would require a laborious and time-consuming process including: (i) unbolting and removing belt safety guard 63 and removing the drive belt 62 and the shaft pulley 60 from the mill apparatus 56; (ii) unbolting and removing all nine side plates 64 and all nine corner plates 65 containing a total of 243 bolts; (iii) unbolting and removing all five segmented divider (orifice) plates 81 from the exoskeleton of the apparatus; (iv) removing the mill top plate 69 from the apparatus 56; (v) removing the central rotating shaft 58 with its affixed processing rotors 75 out through the top of the apparatus; (vi) removing the processing rotors 75 from the central rotating shaft 58 with locating keys and keyways 80, replacing the appropriate processing rotors 75 with locating keys and keyways 80 onto the keyed central rotating shaft 58; (vii) replacing the central rotating shaft 58 assembly with processing rotors 75 into the exoskeleton; (viii) replacing the mill top plate 69; and, (viii) replacing all 243 bolts from side plates 64 and corner plates 65, torquing each to specification in sequence; and, (ix) replacing mill shaft pulley 60, replacing and re-tensioning the drive belt 62, and bolting into place the belt safety guard 63.

By way of comparison, reconfiguring the number of processing chambers 22 in the new PulseWave QD apparatus 1 can be done relatively quickly and easily in a process that would involve: (1) disconnecting the mill to motor shaft coupler 14; (ii) loosen the fasteners on hinged mounting plate 19 for electric drive motor 19 and swiveling the electric drive motor 5 out of the way; (iii) unbolt, swing open, and remove all three hinged, removable outer doors 7 from the three hinge pins 10; (iv) unbolt and remove mill top plate 30; lift the central rotating shaft 3 assembly out the top of the apparatus 1; (v) slide the splined shaft spacers 49, splined processing rotors 21, and optional splined harmonic balancer 4, splined air bearing platen 35, and/or splined internal mill discharge aspirator 44 off the top of the splined central rotating shaft 3 of the apparatus 1; (vi) slide the preferred splined 37 components back onto the splined central rotating shaft 3; set the complete central rotating shaft 3 assembly back onto the mill bottom plate 51; (vii) replace the mill top plate 30, and reaffix a matching set of hinged, removable outer doors 7 configured to match the number and size of the selected processing chambers 21. This operation would be conducted in a very small fraction of the time as compared with the prior art PulseWave NRD apparatus 56 and other prior art devices as a result of the relatively quick and easy access afforded as a result primarily of the hinged, removable outer doors 7 providing rapid access and the splined 37 components being readily removable and replaceable onto the splines central rotation shaft of the apparatus 1.

In implementations of the PulseWave QD apparatus, distributor rotor 32, as the first or topmost processing rotor, may be of a pentagonal, heptagonal, or nonagonal design and may be of a different diameter from the other processing rotors 22, dependent upon the material to be processed and the result desired. For example, in processing mine tailings, common implementations of the distributor rotor in the PulseWave QD apparatus 1 may be heptagonal in shape with a plurality of processing rotor vanes of larger height and thickness. However, the most common implementation of the distributor rotor 32 in the PulseWave QD apparatus 1 is of a nonagonal design and of equal diameter to the next lower processing rotor 22.

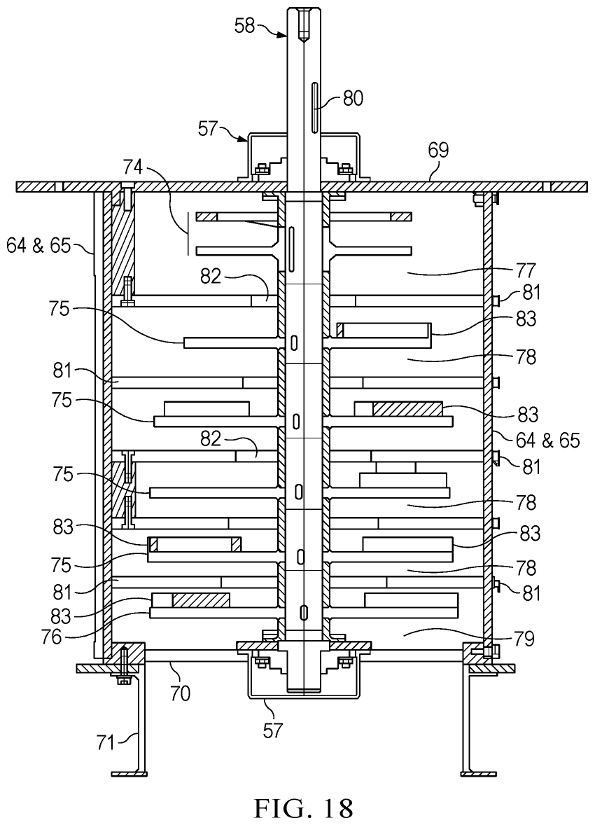

By comparison, and referring to FIG. 18, the most common implementation of the PulseWave NRD apparatus employs a distributor rotor 74 of a sandwich style heptagonal design and of a smaller diameter than its next lower processing rotor 75.

Both PulseWave apparatuses have upper and lower bearings that support their central rotating shafts at its top end and its bottom end, which bearings can be of a standard roller type or may include optional low friction air bearings 43 in an implementation of the PulseWave QD apparatus.

The PulseWave QD apparatus 1 contains nine Primary Vortex Disrupter Pins 17 affixed to the segmented wear plate assemblies 15 formed as the exterior surfaces of each processing chamber 21, being the interior surfaces of the hinged, removable outer doors 7 of the device. Thus, for example, there are 54 Primary Vortex Disrupter Pins 17 in a six-chambered implementation and 27 in a three-chambered implementation thereof. The Primary Vortex Disrupter Pins 17 present in each processing chamber 21 promote substantial disruptions to the basic laminar flow of the fluid stream within the apparatus in converting the fluid stream to a more turbulent or chaotic flow, while other selective components may amplify those disruptions.

By way of comparison, the PulseWave NRD apparatus contains three Primary Vortex Disrupter Pins 84 in each of its processing chambers 78, being a total of 27 Primary Vortex Disrupter Pins 84 in the common six processing chambers 21 implementations thereof. The three Primary Vortex Disrupter Pins 84 in the PulseWave NRD apparatus 56 are positioned at the apices of only three of the polygons formed at the juncture of the side plates 64 comprising the outer walls of each processing chamber 78. Since there are fewer Primary Disrupter Pins 84 formed in the outer edges of its processing chambers 78, the PulseWave NRD apparatus is not configurable as with the PulseWave QD apparatus and therefore not comparatively as efficient in processing certain materials.

Referring again to FIG. 4A, Primary Vortex Disrupter Pins 17 in a PulseWave QD apparatus, when viewed from the top of the apparatus 1, appear as a generally cylindrically-shaped elongated component with gently rounded edges at the point where it smoothly mates with the segmented wear plate assemblies 15 and being exposed to the processing chambers 21 at the point where the outer peripheries of the processing rotors 22 pass in close proximity thereto, generally within approximately one-tenth of an inch. In addition to creating changes to the fluid flow, the Primary Vortex Disrupter Pins 17 provide additional stability to the segmented divider plates 18 while acting as spacers to maintain the appropriate distance between the segmented divider (orifice) plates 18 thus defining the upper and lower perimeters of the processing chambers 21 and the volumes thereof.

While the Primary Vortex Disrupter Pins 84 in the PulseWave NRD apparatus 56 create similar reactions within the fluid flow, they are more diamond-shaped and there are only three in each processing chamber 78 as opposed to nine per chamber in the PulseWave QD apparatus 1.

Implementations of the PulseWave QD apparatus 1 contain segmented divider (orifice) plates 18 that extend inwardly from the internal sides of the hinged, removable outer doors 7 to a central aperture which provides an orifice 40 around the central rotating shaft 3. A central rotating shaft 3 with 18 equally-spaced longitudinal splines 37 extends substantially along a longitudinal central axis of the housing. Processing rotors 22 each include a hub with 18 equally-spaced splines 37 for fitting upon the central rotating shaft 3 for rotation therewith, and substantially polygonal-shaped processing rotors centrally fixed to the hub and having apices and sometimes with optional Secondary Battlement Vortex Disrupters 29 formed therein.

The segmented split divider plates with orifice in the hinged, removable outer doors of the PulseWave QD apparatus 1 can be kept in closed position by insertion of cap screws and nuts in matching bolt holes in mated surfaces. Each horizontal processing chamber 21 in this implementation includes a processing rotor 22 with forged or cast hub of steel or stainless steel containing 18 equally-spaced longitudinal splines for affixing to the similarly-splined central rotating shaft 3 as well as similarly-splined shaft spacers 49 that are available in various lengths to provide the proper spacing above and below the processing rotors 22 and thus their positioning within the processing chambers 21 in various implementations of the apparatus for selected processing applications. This design configuration allows relatively quick and easy open access to the interior of the PulseWave QD apparatus 1

By way of comparison, the prior art PulseWave NRD apparatus 56 incorporates fixed, bolted side plates 64 and overlapping corner plates 65 that comprised the outer walls of its processing chambers 78, and its segmented split divider plates 81 with orifices 82 are bolted to the sides of the mill's exoskeleton and not as easily removable.

By way of comparison, the PulseWave NRD apparatus 56 requires removing individually fixed-bolted side plates 64 and overlapping corner plates 65 that comprised the outer walls of its processing chambers 78, and its segmented split divider plates 81 with orifices 82 are bolted to the sides of the mill's exoskeleton and not as easily removable.

The outer perimeters of the processing rotors of both PulseWave apparatuses 1 and 56 pass, with regard to the curvature of the Primary Vortex Disrupter Pins, closest the interior of the processing chambers, a gap that generally is equal to approximately 1/10 of an inch, the gap thus determining the size of a processing rotor within a processing chamber by its proximity to the Primary Vortex Disrupter Pins.

Each of the processing rotor vanes on a vaned processing rotor of either of the PulseWave apparatuses 1 and 56 can be positioned to extend to the outer periphery of its processing rotors or to provide a small overhang over the peripheral edge of the thereof, and positioned with respect to an apex of the processing rotor such that a leading surface of the processing rotor vane, defined with respect to a direction of rotation, is at the apex. An end of each of the processing rotor vanes being located near an apical corner can be shaped like the peripheral edge at that location.

The PulseWave QD apparatus 1 can be relatively quickly, easily and uniquely configured and reconfigured in large part due to its splined central rotating shaft onto which may be placed and replaced components with matching splined hubs such as its splined processing rotors and splines shaft spacers.

In order to prevent the introduction of small particles into the hubs of splined processing rotors 22, splined shaft spacers 49, splined air bearing platens 35, and splined internal mill discharge aspirators 44, thus potentially acting as a hindrance to easily sliding those components onto and off the central rotating shaft 3 of the apparatus for servicing or reconfigurations, O-ring grooves 50 are formed into analogous surfaces of all the hubs thereof to support the insertion of O-rings therein. An O-ring is a ring of pliable material, as rubber or neoprene, used as a gasket or seal between mating surfaces. Thus, O-rings inserted into the grooves of the various hubs that mate precisely to one another act as an effective barrier in preventing processed materials from migrating from the processing chambers 21 to spaces between the central rotating shaft 3 of the apparatus and splines components fitted thereunto.

By comparison, the prior art PulseWave NRD apparatus 56 has a smooth central rotating shaft 58 with fixed keyways 80 machined into the surface thereof for joining of components with keys that interface with similar keyways 80 machined into the joined components such as its processing rotors 75. Since keyways are in fixed positions, the opportunity to reconfigure the components attached to the central rotating shaft of the PulseWave NRD apparatus is limited or sometimes not possible except by re-machining its central rotating shaft 58.

The spinning distributor rotors in implementations of both PulseWave apparatuses 1 and 56 create low pressure therebelow that assists the gravity feed of material from the feed hoppers and chutes thereof by sucking the feed material and fluid mixture into the inlet processing chambers where the material in the fluid flow is then processed before passing through the orifice at the bottom thereof and discharged into the next adjacent processing chamber. Each successive processing rotor creates additional low pressure environment that further assists in pulling the processed material through the various processing chambers of the device until it is discharged from their bottommost, or discharge processing chambers.

The pressure differential between the processing chambers in both PulseWave apparatuses 1 and 56 allows material and the air or other atmospheres comprising the fluid in which it is entrained to pass from top to bottom of the apparatuses. The fact that flow is in the direction of slightly decreasing pressure is not paradoxical, and results in an increase in the velocity (speed of flow) of the particles during passage through the orifices formed at the centers of the segmented divider plates.

This velocity increase comes from greater suction action produced by the coupled effect of each lower processing chamber creating additional suction and hence increased velocity of the fluid flow. These velocity steps provide the momentum for particles to pass from one processing chamber to the next in implementations of both PulseWave apparatuses.

In implementations of both PulseWave apparatuses 1 and 56, probes not limited to measuring temperatures and pressures can be inserted into their processing chambers via accessory ports. The same accessory ports or other fluid injection ports can optionally be used for injection of optional fluids, catalysts, or coatings.

Implementations of both PulseWave apparatuses 1 or 56 may include straight, curved, or semi-curved processing rotor vanes and may be of different shapes such as, for example, a concave shape on the leading side in a clockwise rotation with the trailing side may be optionally filled and rounded as opposed to having flat backsides. Processing rotor vanes may also optionally be of heavier-duty construction and may optionally contain a larger rounded top edge 23 to promote more efficient distribution to the outer periphery of the processing chamber 21. Implementations may reflect increased vane height at the hub end of the processing rotor vanes based on needed pressure and material/fluid density throughout the apparatus. For example, the processing rotor vanes of a rotor may be taller, thicker, or shaped differently than those of another processing rotor. Taller processing rotor vanes, for example, may allow less material to flow over the its top side, and therefore may more efficiently direct the processed materials outwardly toward the various vortex disrupter mechanisms that enhance comminution.

In optional implementations of either PulseWave apparatus 1 or 56, the separation between the segmented divider (orifice) plates may be the same, as for example in common implementations of the PulseWave QD apparatus 1, or the separation may be reduced with increasing distance of each processing chamber from the top end of the apparatus, as with common implementations of the PulseWave NRD apparatus 56, each apparatus thus having the option of maintaining the same size or reducing the size of each successive processing chamber.

Selecting other optional configurations such as with common implementations of the PulseWave NRD apparatus 56 to increase the diameter of each succeeding processing rotor 75 more distant from the topmost rotor 74, as opposed to common implementations of the PulseWave QD apparatus 1 maintaining the same diameter of its processing rotors 22 throughout may function as a means to induce pressure variations within the apparatuses, thereby inducing small resonant frequency variations and flow characteristics therein. Common implementations of the PulseWave QD apparatus 1 teach equal separation of the segmented divider plates 18 resulting in processing chambers 21 of equal volumes, and equal diameter processing rotors 22, while common implementations of the PulseWave NRD apparatus 56 teach reduced separation of its segmented divider plates 81 and therefore reduced volumes of its processing chambers 78 and an increase in diameter of its processing rotors 75 with increasing distance from the mill top plate 69 thereof.

As compared to the prior art PulseWave NRD apparatus, the design of the PulseWave QD apparatus allows for a dramatic reduction in the time required to completely render the processing chambers 21 to a fully exposed condition for inspection, repair, and to conduct routine cleaning of the device such as when changing production from one material to another where cross contamination is not acceptable. This accounts for a substantial savings of labor as great as 10 hours or more per deep cleaning session, and substantially reduces production downtime and thereby costs associated with those operations. These savings in manpower costs and lost production times alone can result in significant improvement to the financial performance of the operator, since deep cleaning sessions can be a frequent part of machine operation and maintenance.

The process and methods set forth herein as applicable to various materials are characterized in U.S. Pat. Nos. 6,405,948; 6,726,133; 6,991,189; 10,065,193B2; 10,829,707B2; and 10,876,048B2; Australia patent 2002 336425; Israel Patent 160587; New Zealand Patent 541239; and South Africa Patent 2004/1982 and the disclosure of each of these patents is incorporated herein by reference, and are applicable to the new PulseWave QD apparatus 1 and the prior art PulseWave NRD apparatus 56 as set forth in these disclosures.

The disclosure of U.S. Pat. No. 6,405,948, incorporated herein by reference, for example relates to utilizing an apparatus in conjunction with methods of liberating intracellular matter from biological material having cells with cell walls and includes subjecting the biological material to rapid pressure increases and decreases, and exceeding the elastic limit of the cell walls with the pressure increases and decreases, thereby opening the cell walls and liberating the intracellular material from the cells.

The present disclosures refer to processing of hemp materials within apparatuses capable of acting on said materials in a manner whereby the use of resonance disintegration and/or other PulseWave QD Forces on the hemp materials and particles of said hemp materials resulting from said processing is said to constitute non-mechanical impact processing. It is to be understood that the term “non-mechanical impact processing” or “non-impact processing” as used herein encompasses processing wherein mechanical impacts of said hemp materials occur but to a lesser degree whereby damage to said hemp materials as disclosed herein is minimized.

Implementations of the PulseWave QD apparatus 1 and the PulseWave NRD apparatus 56 may be used in practicing the methods of the present disclosure, providing numerous advantages over conventional mechanical grinding or impact comminution apparatus and prior art devices. Implementations of the apparatuses can be operated at different speeds generally from 500 to 5,000 rpm and within a wide range of different frequencies as described herein, lower rotational speeds generally in the range of 500 to 2,500 rpm being effective for resonance decortication and liberation of hemp bast fiber and hurd from the hemp stalk materials, and higher rotational speeds generally in the range of 2,500 to 5,000 rpm being more effective for increased comminution of the processed materials. Favored rotation speeds are selected in conjunction with also selecting the preferred direction of rotation of the processing rotors of the apparatuses.

Unlike the present apparatuses, prior art decorticators, often in conjunction with retting processes as described earlier herein, rely upon mechanically impacting the raw hemp materials to cause the particles to separate from the stalk. Such retting processes can involve allowing microorganisms and moisture to rot or degrade the surface of the plant such that the pectin holding it together is slowly broken down.

Those processes can include dew retting, water retting, warm water retting, green retting, or chemical retting. Chemical retting is considerably faster than the other processes, but includes the use of such chemicals and combinations of chemicals as: hydrogen peroxide, water, and sodium hydroxide; sodium hydroxide, sodium sulfide, and acetic acid; sodium carbonate, sodium hydroxide, and sodium sulfide; caustic soda; anthraquinone and sodium bisulphite and can include acidic souring and alkaline boiling.

Many of those chemicals and processes can leave odors and/or substantial residues, often harmful to the environment. Contaminated water often shows exorbitant chemical oxygen demand, biological oxygen demand, total dissolved solids, sulfide content, and a blackish-brown color.

Besides polluting environments, the uses of chemicals in the retting process increases the costs of operations. Suitable industrial processes for water and chemical retting have not been developed. Although retting, while time-consuming, costlier, and often pollutive, can make it easier to remove bast fibers using prior methods, it is a primary cause of higher bacterial activity in hemp due to contamination from retting or semi-retting processes.

In operation, pre-cut sections of hemp stalks are fed into one or more implementations of the PulseWave QD 1 or PulseWave NRD 56 apparatus such as described herein. The hemp stalks become entrained in a gaseous flow created by a plurality of processing rotors moving at speeds on the order of approximately 500 to 5,000 rpm as an exemplary range of rotational speeds based on the results desired from such processing, including, for example, whether a primary preference is liberation of bast fibers from the stalks, liberation of the woody pulp material from the stalks reducing the woody pulp materials to coarse segments or a fine powder, or otherwise. The lower speeds approximating the range of 500 to 2,500 rpm lend the apparatuses to better decorticate and liberate the hemp stalk materials and render a larger particle of woody materials, while higher rpm generally from 2,500 to 5,000 lends the apparatuses to smaller comminution of particles. As such, the apparatuses can be conformed to either decortication or greater comminution in part by selecting the configuration of the device and in part by selecting the rotational speed of the main shaft of the apparatus. The alternating increasing and decreasing pressures to which the hemp stalks are subjected causes the hemp material to flow in an alternating outward and inward flow around peripheral edges of said processing rotors and through orifices formed in dividing plates with orifices positioned between adjacently located pairs of a plurality of rotors, each orifice plate extending inwardly from internal walls of a housing containing the processing rotors and segmented divider (orifice) plates to a central aperture that provides an orifice about a shaft to which the rotors are mounted for rotation. Pressures acting on the hemp material alternately increase and decrease as flow passes through each orifice and expands in that space below each segmented divider (orifice) plate. Compression and decompression occurs in the flow as processing rotor vanes on the processing rotors pass by static structures referred to as Primary Vortex Disrupter Pins contained within the processing chambers. The compressions and decompressions may differ in magnitude and duration. The flow of material within the apparatuses is substantially without high angle impacts of the hemp materials on structural portions of the apparatuses.

The definition of hemp stalks as contemplated herein further refers to the stalks, sometimes referred to as stems, of hemp plants as a subspecies Cannabis sativa, at least certain products produced according to the present disclosure, the fiber components being suitable for use as components or pre-components for nonwoven geotextiles/matting, non-woven insulation, fiberglass substitutes, industrial fabrics, automotive components (such as door panels, dashboards, etc.), shoes, ropes, clothing and textiles, and supercapacitors having characteristics not previously known in the art, and the hurd components being suitable for use as components or pre-components for bioplastics, plastic additives, absorbents, animal bedding, animal litter, mulch & biochar, wood substitutes, paper & pulp, hemperete, particleboard, cellulose, and as components in lime plaster. The fiber and hurd components liberated in accordance with the methods of the present disclosure can have characteristics not previously known in the art.

The process and methods are also found to be highly effective on the stalks of kenaf plants and other materials

Hemp materials as defined above are subjected as whole materials or as at least partially segmented or fragmented materials to processing using resonance disintegration such as within an implementation of the prior art PulseWave NRD apparatus 56 and sometimes in conjunction with the PulseWave QD Forces as within an implementation of the PulseWave QD apparatus 1 to liberate the fiber and hurd components via resonance decortication and liberation within the apparatuses. The apparatuses subject hemp materials to rapid pressure increases and decreases and rapid directional changes in a high velocity fluid stream causing shearing forces and increased particle-to-particle collisions while the processed materials are entrained in a Coanda flow that minimizes contact with the apparatuses. The processed materials are also simultaneously subjected to the forces created by the PulseWave apparatuses including inter alia application of the physics of destructive resonance by subjection to shock waves, resonance, vortex-generated shearing forces, and other forces acting thereon in thousands of incremental steps to selectively differentiate and fragment particles in complex multi-phase materials such as the hemp stalks defined herein.

According to present disclosure, segments of hemp stalks are fed into an implementation of the PulseWave QD apparatus 1 or the PulseWave NRD apparatus 56 such as to cause the separation and liberation of the hemp bast fibers and hurd from the hemp stalk in a process called resonance decortication. Processing in atmospheres of air, steam or other gas can cause effective liberation of the hemp bast fibers from the hemp stalks within either apparatus in the general range of 500 rpm to 2,500 rpm as exemplary rotational speeds in clockwise and counterclockwise directions. Subjecting the materials to resonance disintegration combined with other forces employed to generate resonance and other forces acting on the particles or to generate other effects on the particles induces the liberation mechanisms to occur substantially without mechanical impact between the hemp particles being processed and the surfaces of the apparatuses. These forces generated within the PulseWave apparatuses, with or without the modifications inherent to the PulseWave QD apparatus 1 as described herein, include pulses generated by increasing and decreasing pressure changes acting on the hemp materials contained in high velocity streams, shearing forces, and g-forces.

Processing of raw hemp materials according to the present disclosures produces particles having little or no oils initially existing in the hemp smeared over surfaces of the liberated particles. Such oils include fatty acids that, when released from natural locations within hemp plants by mechanical impact processing, begin to oxidize to aldehydes, alcohols and peroxides, thereby causing the resulting hemp products to degrade, and to lose organoleptic, nutritional, commercial, and character value. Processing according to the present disclosure reduces or eliminates any release and/or smearing of the oils inherently present in the raw hemp materials with the result that oxidation is held in check.

Hemp stalks, typically ground into pieces by mechanical impact processing sometimes in conjunction with a retting process, must often be used without lengthy delay due to the fact that spoilage can begin almost immediately. Hemp fiber and hemp hurds produced according to the present disclosures are shelf-stable with no appreciable spoilage or loss of value due in part to the fact that oils inherently present in the hemp materials do not oxidize appreciably after processing in the apparatuses. The hemp materials thus produced according to the present disclosures are not only resistant to spoilage but also do not introduce the oxidation products present in some hemp materials processed using mechanical impact devices possibly in conjunction with certain forms of retting. Therefore, the hemp materials produced according to the present disclosures are more natural and are not exposed to spoilage or rancidity due to the relative lack of oxidation products in the present materials.

Further, processing of hemp components by mechanical impact processing damages the materials such as by damaging starches and the like, thereby facilitating enzymatic degradation by amylase and the like. The reduction in moisture levels in the hemp materials processed according to the present disclosures also tends to neutralize amylase and other enzymatic activity. The rapid, non-mechanical impact processing afforded by the methods of the present disclosure using resonance disintegration and/or other PulseWave QD Forces causes oils and the like within the hemp materials to remain in natural “packets” or inclusions, whereby such inclusions remain essentially intact and are thus not spread or smeared over surfaces of the hemp materials or particulate thereof, adsorbed thereon, or absorbed into the materials or particulate. Oxidation can also be decreased by processing of hemp materials according to the methods of the present disclosures in gaseous atmospheres such as nitrogen and other atmospheres from which oxygen has been substantially removed.

The methodology of the present disclosure preferably comprises subjection of hemp stalk materials to alternating increasing and decreasing pressures, which may include shock waves, with abrupt directional changes in a high velocity stream to produce essentially instantaneous changes in forces acting thereon, thereby to reduce the material so processed along natural cleavage planes and along physiochemical boundaries therein with a resulting liberation of the fibrous component and the hurd component of the hemp stalk material being processed. The methods may be practiced within an apparatus such as the PulseWave NRD apparatus 56 disclosed in the aforesaid United States patents incorporated hereinto by reference, and to other implementations thereof as herein mentioned such as with the PulseWave QD apparatus 1, sometimes referred to herein as a “mill,” such processing occurring in a substantially non-impact or low-impact manner with energy efficiencies not possible with processes involving mechanical crushing and grinding of hemp stalks to decorticate the hemp bast fiber and the hemp hurd from the stalks by conventional processing, sometimes including a retting process as described earlier herein. In the methods of the present disclosure, hemp hurds and hemp fibers are liberated from the hemp stalk in the resonance decortication process while effectively avoiding mechanical crushing as occurs with use of prior apparatus such as hammer mills, pin mills, ball mills, knife mills and the like which can invariably cause damage to the bast fibers among other deleterious effects.

The methods of the present disclosure, employed in implementations of the PulseWave apparatuses such as those disclosed herein, induce forces in the materials to gently pull the fibrous materials away from the stalk and to simultaneously liberate the woody hurd material without mechanical impact effects on the particles. Non-canceling harmonics can be utilized to facilitate resonance within the apparatuses, and processing and speeds within entrained flows can be varied according to the definition of processing in the present disclosures. Standing waves can be generated within such apparatus to further facilitate non-mechanical impact reduction of particle sizes.

Processing in vertically-oriented or horizontally-oriented implementations of the apparatuses can be effected according to the present disclosures.

The present disclosure is further directed to using implementations of the PulseWave NRD apparatus 56 and the PulseWave QD apparatus 1 in conjunction with the methods for comminuting hemp fiber materials liberated from raw hemp stalk segments comprising subjecting at least one hemp stalk segment to non-impact processing to reduce the size of the fiber from the raw hemp stalk segment commensurate with the use of such fiber as a component in commercial products such as with subjecting the hemp stalks to very low temperatures as with liquid nitrogen or other cryogenic materials, thus causing the PulseWave apparatuses to perceive the material as more crystalline and to more effectively comminute it. The non-impact processing in the apparatuses may comprise using resonance disintegration and/or other PulseWave QD Forces. The methods may further comprise selectively reducing the size of the fiber.

These methods of processing hemp stalks using either PulseWave apparatus eliminates the need for retting and its associated wait times, higher costs, pollution, and potentials for contamination. These methods further allow for newly-harvested hemp to be processed immediately without the use of partial rotting processes, chemical, or solvents.

The processing of hemp stalks may be performed utilizing either PulseWave apparatus by employing shearing forces, particle-to-particle collisions, and destructive resonance forces, referred to herein as resonance disintegration sometimes in conjunction with other PulseWave QD Forces, and the related effects thereof. Processing in either PulseWave apparatus according to the present disclosure simultaneously liberates the bast fiber materials and the hurd materials from the hemp stalk substantially without substantial machine-to-particle impacts and thus without crushing or grinding with the usual weakening or damage and lower end material quality as occurs with mechanical impact processing sometimes combined with retting processes.

Bast fiber material produced using either PulseWave apparatus according to the present disclosure is of enhanced quality when compared to typical material produced by traditional decorticating processes utilizing retting techniques followed by mechanical impact processes. Hurd material produced according to the methods of the present disclosure is resistant to rancidity or spoilage and retains high antimicrobial qualities, making it ripe for a wide range of commercial utilization. Processing of hemp stalks according to the present disclosure therefore constitute substantial advances in the art.

Implementations of methods disclosed herein in conjunction with processing in the PulseWave QD apparatus 1 or the PulseWave NRD apparatus 56 subjects hemp materials to rapid pressure increases and decreases and rapid directional changes in a high velocity fluid stream causing shearing forces and particle-to-particle collisions while the processed materials are entrained in a Coanda flow that minimizes contact with either apparatus. The processed materials are also simultaneously subjected to the forces created by either apparatus including inter alia subjection to shock waves, resonance, and vortex-generated shearing forces acting thereon in thousands of incremental steps to isolate and remove the bast fiber and the hurd (shivs) from the hemp stalk material using the methods while the fiber and the hurd components are made separate from one another in a process called liberation whereupon they may be easily separated by classification techniques based on physical differences between a comminuted fraction of the fibrous material and the hurd material. The methods of the disclosures further reduce moisture content of the materials by subjection of such materials to the effects of the forces acting upon them within the apparatuses. This combination of shearing forces, particle-to-particle collisions, and destructive resonance forces are sometimes collectively referred to herein as resonance disintegration and sometimes in conjunction with the PulseWave QD Forces.

In one implementation, the method of decorticating the fiber and hurd materials and liberating those components one from the other includes the steps of entraining the material in a gas flow by subjecting the flowing material within a housing of either PulseWave apparatus having alternating processing rotors and segmented divider (orifice) plates to a plurality of alternating pressure increases and decreases, shock waves, resonance, and vortex-generated shearing forces multiplied by the addition of thousands of incremental steps that disintegrates the flowing material with these forces generally referred to as resonance disintegration and/or PulseWave QD Forces, thereby removing the material from the hemp stalk and discharging the disintegrated material though an outlet of the apparatus.

In various implementations of the PulseWave QD apparatus 1 and the PulseWave NRD apparatus 56, the methods of the present disclosures comprise subjecting portions of hemp stalks to rapid pressure increases and decreases and rapid directional changes in a high velocity fluid stream to instantaneously vary forces acting thereon. Those forces can include resonance disintegration and can be produced in an apparatus embodying an inlet processing chamber, other processing chambers, and a discharge processing chamber. Each processing chamber contains a spinning processing rotor and may be separated by solid or segmented (split) divider plates with an orifice formed at the center of each, the PulseWave QD apparatus 1 being abundantly configurable and reconfigurable into more than 829,440¹ combinations to more efficiently process a given material and to achieve a desired result.

In implementations of both PulseWave apparatuses, with or without the modifications inherent to the new art PulseWave QD apparatus 1 as described herein, the design of the processing rotors and the processing rotor vanes formed thereon may be of different sizes, shapes and numbers and more fully described herein and work in conjunction with Primary Vortex Disrupter Pins that may be of the same or various lengths, designs, and numbers affixed between the segmented divider (orifice) plates to help direct the fluid flow, create turbulence, optimize processing, and minimize wear on the apparatus while causing a more efficient operation of the devices.

Bast fibers and hemp hurds can be produced according to the present disclosure with characteristics as noted herein including product high quality, lower moisture, and improved shelf life.

The process and methods can similarly be utilized in both PulseWave apparatuses to efficiently liberate the fibers and woody core materials from Cannabis and kenaf stalks without the requirement for an external decorticator or the use of retting prior to processing, the PulseWave QD apparatus 1 being highly configurable such as to improve the efficiency of processing any given size, density, moisture content, or other characteristics of the hemp or other material being acted upon.

The application of the present disclosures to process biological materials in either PulseWave apparatus, and in particular plant and fungal material including hemp, has several advantages over prior art mechanical grinding or impact pulverization methods. Either PulseWave apparatus can be operated at different rotational speeds and in a clockwise or counter-clockwise direction of rotation and can generate a wide range of different resonating frequencies. Hence, both PulseWave apparatuses are versatile instruments for generating forces needed for resonance disintegration sometimes in conjunction with other PulseWave QD Forces acting on the materials. Heat generated during the process is modest and hence heat-sensitive biological molecules are not destroyed. An apparatus using the methods of the present disclosure can also accommodate materials that have significant moisture content. During processing, moisture is driven off resulting in a dry or dryer product. When the moisture content of the biological material is sometimes as high as approximately 40% or less by weight, the liberated intracellular materials may be in the form of relatively dry components. Using the methods of the present disclosure and an apparatus operated at increased rotational speeds can decrease the size and increase the available exposed surface of the intracellular material for more efficient extraction with aqueous or organic solvents.

When plant or fungal material is processed, cellulose particles in the product have a generally larger size than other product materials. These properties each make the desired material easier to separate from the cellulose, for example, with a classifier or by screening after processing in the PulseWave apparatuses utilizing the process and methods described herein. A purer and more efficacious product is produced. The liberating process can be carried out without the use of retting or chemicals or solvents, thereby making a more pure product and reducing the risk of chemically altering the product. Bulk materials, including pieces of plant fungal and animal matter, can be processed according to the present disclosure. More pure and more concentrated product of intracellular material can be produced according to these methods in a cost effective manner. An added benefit of using the methods of the present disclosures in conjunction with either the PulseWave QD apparatus 1 or the PulseWave NRD apparatus 56 to liberate intracellular products from biological material is that bacteria can be destroyed in the process, thereby reducing the bacterial load of the finished material.

An apparatus also decorticates and liberates discrete material of dry or high moisture content with shock waves created by flowing the material through a housing having alternating processing rotors and segmented divider (orifice) plates. The housing includes a first end having a feed hopper and chute for introducing the material into the processing chambers thereof, a second end having an opening for removing from the apparatus the decorticated and liberated materials and other waste produced in the process. Processing rotors sometimes have a plurality of processing rotor vanes, each extending approximately radially inward on a side of the processing rotor from an outer apex thereof.

Conventional milling methods, often in conjunction with retting processes, operate to simply pre-rot, crush and possibly separate bast fiber materials from the basic plant structure with a resultant damage to the hurd component present in such hemp materials as defined herein and with relatively high energy costs and the potential for damage including microbial contamination attendant to retting activities.

Processing according to the present disclosure incrementally increases the magnitude of shock waves generated within an apparatus and phases forces to enhance process efficiency while minimizing energy transfer to structural portions of the apparatus and to the materials being processed. Hemp stalks are fragmented from within according to practice of the present methods rather than being crushed by mechanical impacts as in grinding and crushing processes. The bast fibers and the hurd (shivs) thereby cleave along internal planes most susceptible to separation, those most favorable planes in plant materials being boundaries between portions of the materials such as the stems as examples of at least some of the hemp as defined herein. For example, various plant materials (stems, leaves, berries, seeds, roots, etc.) are fragmented in a manner that dissects components into different particle sizes. More elastic, fibrous components are larger and intracellular and intercellular non-fibrous matrix components are smaller. Using selective screening or other separation methods, dry fractionation of components is thus possible. In contrast, homogeneous materials such as a mineral salt or the aluminum of a container are processed into particles quite uniform in size, (e.g. a narrow bell curve of particle size distribution).

Most materials to be processed have an inherent resonant frequency that, when attained, causes the materials to vibrate apart along natural fracture planes, which, when combined with favored particle-to-particle collisions of the materials within the fluid stream and other effects generated within the apparatuses results in an infinitely better and improved method of comminution as opposed to compressing the material to failure, which requires substantially more energy and can damage the material. Both PulseWave apparatuses, with or without the modifications inherent to the PulseWave QD apparatus 1 as described herein, utilize resonance disintegration for comminution and liberation of complex materials, but operators of the PulseWave QD apparatus 1 have the distinct advantage of utilizing any one or more of at least 829,440¹ different available combinations available for relatively quickly and easily configuring and reconfiguring the PulseWave QD apparatus 1 in determining the most favorable combination for a particular material to be most efficiently processed.

In implementations of both PulseWave apparatuses, materials are fragmented from within in processes assisted by Piezoelectric forces generated thereby rather than being crushed to failure by impact or by grinding.

The processes of the disclosure utilizing either PulseWave apparatus can cleave crystalline materials apart along the natural planes of their structures, and can selectively fragment into individual components various materials of heterogeneous composition, with harder, less elastic components generally being fragmented into smaller comparative particle sizes than softer, more elastic components. Because the PulseWave apparatuses do not rely upon crushing or grinding forces to cause comminution and liberation of materials and their components, they do not cause agglomeration or “smearing” of the different material components during the process.

Traditional prior art impact-based milling machines relying upon kinetic energy may cause mechanical damage to the cells or components of the processed material, including agglomeration, whereby the various components of a complex, multiphase materials become a jumbled cluster or mass of the varied parts. By way of example, in reducing raw coal to smaller sizes for use in pulverized coal combustion (PCC) facilities using a traditional ball mill or roller mill, the coal is inexorably crushed together, or agglomerated, with mercury and other pollutants into numerous single clusters prior to combustion, thus causing pollution to the air and the environment. Both the PulseWave QD apparatus 1 and the PulseWave NRD apparatus 56 of the disclosure not only eliminate the problem of agglomeration, but also liberate a large portion of the pollutants from the clean coal particles prior to combustion. Agglomeration from impact-based milling devices can render many materials unusable after comminution.

It was observed that strong shearing forces are generated by processing in both PulseWave apparatuses. These forces can be utilized, for example, to blend water and oil phases together in the presence of various detergents to produce emulsions. Emulsions are preparation forms for various nutrients, pharmaceuticals, paints and a wide variety of products used in manufacturing.

For example, a mixture of one part corn oil, 13.5 parts water, and 0.0009 parts Tween 20 was processed in an implementation of a PulseWave apparatus at a speed of 3400 rpm. A creamy-white emulsion was produced. Microscopic examination showed that the preparation was in the form of microscopic globules, with water apparently in the interior of the globules and oil at the surface. The emulsion was observed to remain stable for over one year. It was conceptualized that micro droplets of water become coated with a thin layer, perhaps a monolayer, of oil molecules as they travel at high velocity through the apparatus giving rise to the belief that the PulseWave mill has the potential to produce liposomes, which are lipid membrane vesicles with water containing centers. Liposomes are used in the delivery of pharmaceuticals, nutraceuticals, cosmetic agents and micronutrients. An implementation of the PulseWave mill generated water micro droplets sufficiently small such as to create a stable emulsion of oil and water. An oil covered micro droplet of water is similar to a liposome, the difference being size and the nature of the lipid. Liposomes have membrane composed of phospholipids. It is believed the PulseWave apparatuses can be used to generate shearing forces sufficient to produce liposomes in high abundance with a potential to alter liposome size and complexity.

Both amorphous and regular crystals of non-mineral containing organic compounds are reduced in particle size by the PulseWave apparatuses as with whole plant or animal materials.

The present disclosure relates generally to the processing of raw hemp stalks in either PulseWave apparatus to remove the hemp bast fiber material, which typically comprises roughly 20-30% of the stalk, from the woody hemp hurd material, which typically comprises roughly 70-80% of the stalk, in a process utilizing resonance disintegration and sometimes other PulseWave QD Forces including inter alia resonance decortication to liberate the fiber material from the hurd materials.

Because the PulseWave QD apparatus 1 offers an infinitely greater potential for combinations and recombinations of components than the prior art PulseWave NRD apparatus 56, it has measurably greater potential for more efficiently processing any given material versus the less configurable design of prior art devices.

Use of the process and methods of the present disclosure in conjunction with resonance disintegration employed in both PulseWave apparatuses and sometimes utilizing additional PulseWave QD Forces employed in the PulseWave QD apparatus 1 produces a heterogenous mixture of cell wall fragments and the intracellular material. Where the biological material includes pieces of plant, animal or fungal material, the method can further include separating the cells of the pieces from each other with the pressure increases and decreases when the elastic limit of intercellular bonds is exceeded. Moisture and volatiles in the biological material are simultaneously liberated and vaporized, producing a substantially dry mixture having a lower moisture content than the original material.

The forces of impact, attrition, compression, tension, and concussion are dependent in large part upon the configuration of the PulseWave apparatuses. Those forces combine to accomplish the liberation and comminution of raw hemp stalk materials selected from the group consisting of the stalks and/or stems of hemp plants as a variety of Cannabis sativa plant cultivars as varieties grown for industrial and commercial use as described herein. The process and methods can also be similarly effective in processing stalks of Cannabis and kenaf plants.

The process and methods set forth herein particularly relate to processing of hemp materials using resonance disintegration and/or other PulseWave QD Forces substantially without machine-to-particle impacts and thus without crushing or grinding, such as by subjection thereof to implementations of the PulseWave QD apparatus 1 and the PulseWave NRD apparatus 56 set forth herein and as reflected in the similarities thereto.

Upon entering the PulseWave apparatuses, the incoming raw material is acted upon by a number of forces that can comminute materials comprised of wet or dry discrete objects into relatively smaller particles while simultaneously liberating the various components of complex, multiphase materials using selective differential fragmentation achievable by using vortexes of air, rapid pulsatile pressure changes, and generally-favored indirect particle-to-particle collisions in gently vibrating and pulling the materials apart along natural fracture lines and lines of cleavage without crushing or grinding them into smaller pieces with the attendant usual weakening or damage and lower-end quality of the processed material as occurs with mechanical impact processing as with most prior art comminution devices utilizing antiquated kinetic energy based, impact technology.

Implementations of the PulseWave QD apparatus as described hereinabove can be relatively quickly and easily configured or reconfigured into more than 829,440¹ various combinations and recombinations of the apparatus for the purpose of creating specific and unique arrays of the PulseWave QD apparatus for the purpose of more efficiently processing a given material. This is accomplished by customizing its configuration to better enhance any desired level of shearing forces, particle-to-particle collisions, destructive resonance forces including resonance disintegration, and other collective contributory forces, all of which generally occur within less than one second during passage of materials through the apparatus. ¹See Appendix for Mathematician's Report of available combinations of configuring and reconfiguring the PulseWave QD apparatus.

Thus, the PulseWave QD apparatus 1 is abundantly configurable to achieve the end result desired such as, for example, to further increase efficiency and economy of processing hemp and Cannabis and related materials using the methods described herein to comminute materials while decorticating and liberating fibers and hurd from hemp stalks and related materials using selective differential fragmentation, all of which results in a truly unique and unprecedented ability of the PulseWave QD apparatus 1 to more precisely and efficiently process these or any one of numerous other materials as compared to any prior art device or apparatus.

Referring to FIGS. 1A and 16, raw materials introduced into either the PulseWave QD apparatus 1 or the PulseWave NRD apparatus 56 first enter a feed hopper and chute 27 and 66, respectively, where they pass into the topmost inlet chamber 54 or 77, respectively, before passing through the remainder of the apparatus.

In common implementations of the PulseWave QD apparatus 1 and the PulseWave NRD apparatus 56, before material is fed into either apparatus, its processing rotors are brought up to an operating speed of rotation, inducing generation of a large air flow with negative back pressure through the feed hopper and chute into the mill's inlet chamber. Thus, any material fed into feed hopper and chute will be immediately drawn into the apparatus and accelerated rapidly towards its distributor rotor. At the entry point, the apparatus discharges the material from the feed hopper and chute onto the distributor rotor at a point radially distant from its central hub toward the outer edge thereof such as to contact the outer portions of the distributor rotor vanes.

Material may be broken apart while accelerating down the feed hopper and chute, or while changing direction when passing through the mill top plate. It is believed that the mill top plate inlet ports acts as an orifice similar to those orifices formed at the center of the segmented divider (orifice) plates through which air and the feed-stock material flows into the larger volume region between the mill top plate and the distributor rotor. The flow through this first orifice in the mill top plate can cause a rapid pressure change which may be accompanied by a temperature change. The pressure change, together with the rapid acceleration of the particles exiting the feed hopper and chute, can cause a first shock compression and/or expansion and an initial breaking apart of some particles within the fluid stream, and smaller particles of approximately less than 1 to 1.5 inches (2.5-3.8 cm) in size may be quickly entrained in the Coanda flow.

The collisions in the fluid stream cause the particles to break apart along natural boundaries in conjunction with the other forces acting upon them. In this sort of random, high frequency collision environment, one side of a colliding particle tends to contract while the other opposite side tends to stretch. If repeated numerous times, as occurs within the fluid stream of the PulseWave apparatuses, the end result is enhanced comminution along natural boundaries.

When material to be processed is drawn into a PulseWave apparatus, it is subjected to repeated changes in pressure in a rapid pulsatile manner. This configuration causes a rapid series of primary shock waves to be generated every 40 degrees of rotation of the central rotating shafts thereof and thus the processing rotors as they pass in the vicinity of each interior apical intersection of the processing chambers such that every full rotation of a nine-sided processing rotor within a nonagonal-shaped processing chamber generates 81 of these secondary shock waves compounding the 81 complex primary pulses.

This occurs as a result of the effects created as each given side of a processing rotor approaches its closest position to the outer wall of the processing chamber, which is actually the inward most edge of each of the three Primary Vortex Disrupter Pins 17 evenly spaced in the outer walls of each processing chamber of the PulseWave NRD apparatus 56, and each of the nine Primary Vortex Disrupter Pins in each processing chamber of a PulseWave QD apparatus 1 at the apices of each of the nonagonal-shaped outer walls thereof. The physical width of Primary Vortex Disrupter Pins can be of a narrower or wider construction such as to create a shock wave of longer or shorter phase and duration such as occurs when a processing rotor passes thereby, whereupon occurs maximum compression of the fluid within the stream, commonly, for example, atmospheric air, and its particulate load.

The material in the fluid flow inside a processing chamber of a PulseWave apparatus is forced outwardly by a spinning processing rotor. As the fluid flow reaches the Primary Vortex Disrupter Pins, the newly injected material collides with other material as it passes through and interacts therewith. Some of the material in the flow passes through and is added to the existing counter-rotating vortices on either side of each Primary Vortex Disrupter Pin, and the comminuted particles within the fluid stream are then similarly drawn into the next lower processing chamber where the process repeats.

As material flows through the PulseWave NRD apparatus 56 and PulseWave QD apparatus 1 from one processing chamber to the next, an amplification or multiplier action occurs. This is due to increasing pressure in passing from one processing chamber to the next lower processing chamber. The power of the shock waves and resonance forces that can be generated within each processing chamber is increased in a series of incremental steps as particles flow through the apparatuses in a fluid stream.

These destructive shock waves occur in two steps. First, the fluid flow is accelerated around the outer perimeter of the processing chambers by the action of the rotation of the processing rotors with straight, curved, or semi-curved processing rotor vanes, but is forced to rapidly decelerate as it approaches each of the Primary Vortex Disrupter Pins located around the outer periphery of the processing chambers. Three of these Primary Vortex Disrupter Pins are located in each processing chamber of the prior art PulseWave NRD apparatus 56, while the new art PulseWave QD apparatus 1 employs nine of these Primary Vortex Disrupter Pins in each processing chamber placed at the apices of each two adjacent nonagonal-shaped sides thereof. The spinning processing rotors generate a very rapid compression and decompression action at these Primary Vortex Disrupter Pins as the outer edges of the processing rotors pass nearby, producing a very strong vertical shock wave of very short duration.

To be clear, these primary pulse shock waves in the PulseWave apparatuses are not simple, single waves of uniform amplitude and duration. Instead, each primary pulse shock wave consists of a longer phase, shallow-sloped wave upon which a steep, vertical wave is superimposed. This complexity is a result of two aspects of the processing rotor design in conjunction with passing near the Primary Vortex Disrupter Pins in both devices:

Firstly, the nine flat edges formed at the outer perimeter of each nonagonal-shaped processing rotor generate a more gradual compression and decompression action as each outer edge thereof, together with its attendant processing rotor vane, rotates toward the Primary Vortex Disrupter Pins in the outer walls of the processing chambers. The greater number of nine Primary Vortex Disrupter Pins per processing chamber in the new art PulseWave QD apparatus 1 cause a greater and more frequent number of these actions to occur as opposed to the prior art PulseWave NRD apparatus 56 with only three Primary Vortex Disrupter Pins per processing chamber, thus contributing to a substantial increase in the chaotic flow within the fluid stream.

Secondly, the points at the outer apices of the nonagonal-shaped processing rotors, coupled with a slight extension of the nine processing rotor vanes that extend to the pointed outer edges of the processing rotors, produce sharp, vertical shock waves (compression/decompression) as this region of the processing rotor passes by the Primary Vortex Disrupter Pins. This powerful short duration wave is additive to the first forming, but more gradual, wave. As stated above, this sequence is repeated in each of the PulseWave apparatuses every 40 degrees of rotation as the processing rotor passes in the vicinity of each interior apical intersection of the processing chamber such that every full rotation of a nine-sided processing rotor within the nonagonal-shaped processing chamber generates 81 of these secondary shock waves compounding the 81 complex primary pulses.

This secondary shock wave is superimposed or additive to the primary shock wave which at that point is in the relaxation or decompression phase. Hence, before particles can reach their rebound point they are subjected to an additive, sharply vertical shock wave. At the same time, a vortex is set in motion around the Primary Vortex Disrupter Pins which generates shearing action that further augments the fragmentation of particles as they exceed their limit of elasticity during the relaxation (decompression) stage. Thus, secondary pulsed, standing shock waves even more powerful than the primary pulses are delivered.

These forces are determined in large part by the Primary Vortex Disrupter Pins that are configurable by height, width, and anterior contour. The length of Primary Vortex Disrupter Pins within any processing chamber determines the spacing between the segmented divider (orifice) plates thereof, and thus the volume.

The anterior contour of Primary Vortex Disrupter Pins further determine whether the primary pulse shock waves created thereby are steep or shallow-shaped waves upon which steep, vertical shock waves are superimposed.

As such, the length, width, and contour of Primary Vortex Disrupter Pins within PulseWave apparatuses are formative of the processing chamber volumes and of the type and duration of disruptions created within the fluid stream such as to favor a more efficient processing of any given material.

As materials are flexed by the pulsatile shock waves in both PulseWave apparatuses piezoelectric energy is generated, further enhanced by the effects of spinning processing rotors. Hence the force of electrical discharges may be considerable, depending on the nature of the material being processed. These piezoelectric forces may be additive to the effects of the primary and secondary shock waves.

Both the PulseWave QD and PulseWave NRD apparatuses effectively and efficiently comminute materials into small sizes and liberate the components of complex, multiphase materials using selective differential fragmentation; however, unlike implementations of the prior art PulseWave NRD apparatus 56, implementations of the new PulseWave QD apparatus 1 are relatively quickly and easily configured and reconfigured into more than 829,440¹ combinations and recombinations by introducing numerous proprietary variants into the design and construction thereof such as to more efficiently process a given material.

Both PulseWave apparatuses comminute materials of many different types and descriptions and liberate the components of many complex, multiphase materials, including but not limited to the stalks of hemp plants, using selective differential fragmentation, all in a variety of fluid medias. Both apparatuses incorporate a great number of improvements over prior art kinetic energy impact-based impact milling devices and other known devices for comminuting materials.

In implementations of both PulseWave apparatuses, with or without the modifications inherent to the art PulseWave QD apparatus 1 as described herein, material to be processed is fed into the feed hopper with tube at the top of the apparatus by gravity or fed by mechanical conveyances, and is then further drawn into the apparatus by strong suction created by the forces generated within the apparatus.

Forces within the PulseWave QD apparatus 1 may be amplified by means not available in the PulseWave NRD apparatus 56 by, among other things, inclusion of various optional configurable components such as the internal mill discharge aspirator 44 as further described herein, sometimes in conjunction with a separate post-discharge aspirator device connected to the output of the apparatus.

After material introduced into implementations of either PulseWave apparatus through an inlet port first reaches and is dispersed within the first, or topmost processing chamber, sometimes referred to as the inlet chamber, by the topmost processing rotor, sometimes referred to as the distributor rotor, the initial disorganized flow is forced outwardly in a more organized fashion.

Two counter-rotating vortices counter to the main flow of material are generated within the fluid streams. These include a first, or primary, vortex that is generated by redirecting the fluid flow back into itself with the help of the Primary Vortex Disrupter Pins. Second, as some material continues and passes over the inward most edge in the Primary Vortex Disrupter Pins, the Coanda effect redirects the fluid jet inwards again and along the surfaces thereof. The Coanda effect is herein described in greater detail.

In implementations of both PulseWave apparatuses, newly injected material collides with other material as it passes through or interacts with the circular movement of the fluid flow within the processing chambers and is added to the existing counter-rotating vortexes on either side of each of the Primary Vortex Disrupter Pins. Comminuted particles within the fluid are then forced outwardly by the processing rotors and drawn further into the next chamber through orifices in the segmented divider (orifice) plates based on their specific gravity and other internal factors determined by the configuration of the apparatus, operational speed, and direction of rotation of the processing rotors.

Laminar flow within a fluid stream is characterized by smooth, regular paths of particles lacking any swirls or cross currents within the fluid, and is common in cases in which the flow channel is relatively small, the fluid is moving more slowly, and its viscosity is relatively high. Because laminar flow generates fewer changes in magnitude or direction of the fluid flow, it results in a greater incidence of machine-to-particle collisions that can damage certain raw materials and can result in substantially greater machine wear.

Prior art impact-based milling machines such as hammer mills, ball mills, roller mills, and pin mills are relegated to a much higher occurrence of laminar flow within those apparatuses as the fluid flows within a thin layer adjacent to the surfaces formed by the solid boundaries of their outer walls or is simply hammered into submission during processing. The laminar flow within those devices is disrupted with substantially less frequency and in shorter durations due to the absence of any significant vortex disruptions, thus resulting in greater machine-to-particle collisions and accompanying higher wear.

In contrast to laminar flow, turbulent flow is characterized by the irregular movement of particles within the fluid stream, substantial lateral mixing, and disruption between the layers of the fluid flow characterized by recirculation, eddies, and randomness such as is caused in wake turbulence. In turbulent flow the speed of the fluid at a given point is continuously undergoing changes in both magnitude and direction. This chaotic, or turbulent flow within the PulseWave apparatuses is amplified by the effects of several components of the systems, some inherent in all implementations, such as, for example, with the Primary Vortex Disrupter Pins located within each processing chamber, and some in optional implementations such as the PulseWave QD apparatus 1 employing abundantly more options such as, for example, Secondary Battlement Vortex Disrupters 29, the Quantum Vortex Turbulator System, and the internal mill discharge aspirator, all as herein described.

Referring to FIG. 14A, changes in the flow of fluid may be driven by interactions with an object moving through the fluid or the fluid moving over or near an object, in this case the object being, for example with the PulseWave QD apparatus 1, Primary Vortex Disrupter Pins 17, Secondary Battlement Vortex Disruptors 29 in various configurations, Quantum Vortex Turbulator System, or other components in implementations thereof.

Common implementations of the PulseWave NRD apparatus 56 contain three Primary Vortex Disrupter Pins in each processing chamber placed at the apices thereof in 120 degree intervals, but may optionally be configured to contain nine Primary Vortex Disrupter Pins. As with the PulseWave QD apparatus 1, these Primary Vortex Disrupter Pins account for the spacing between the segmented divider (orifice) plates defining the upper and lower perimeters of each processing chamber, and thus the volumes thereof, in addition to causing beneficial disruptions in the fluid flow.

After determining a suitable configuration for a preferred implementation of a PulseWave QD apparatus 1 to most efficiently process a given material such as hemp stalks, various selected components would be affixed onto the splined central rotating shaft 3 in accordance therewith, and a matching set of three hinged, removable outer door 7 assemblies in accordance with that configuration would then be affixed to the hinge points of the housing for rotating open and closed in conjunction therewith.

Thus, for example, referring to FIGS. 2A, 2B, and 5A, an implementation of the PulseWave QD apparatus 110 configured for four processing chambers 21 is illustrated with processing rotors 22 would include three matching hinged, removable outer doors 7 configured for a four-chamber design and would be affixed to the machine mounting plates 36 on hinge pins 10 allowing for the easy opening and closing thereof to comparatively quickly and easily expose the innermost parts of the apparatus. Hinged, removable outer door 7 assemblies would thus be configurable for implementations of the new art PulseWave QD apparatus 1 utilizing three, four, five, or six processing chambers 21 and could be further configured or reconfigured according to preferential spacing of the processing chambers 21 thereof.

In configurations and reconfigurations of the components of implementations of the PulseWave QD apparatus 1 suitable as a non-mechanical impact device, the processing rotors 22 employed therein can be angularly offset from one other in varying degrees of rotation as set forth herein so that compressions and decompressions are not synchronized. Depending on the rotation offsets in a clockwise or counterclockwise arrangement and the configuration of the components comprising the processing chambers, the number of static interdigitating elements disposed within the housing and other structural characteristics of the device, a series of compressions and decompressions can occur at different frequencies, and pressure change frequencies can be adjusted to resonate to characteristics of various hemp material to more effectively process it. the material being processed.

By comparison, the prior art PulseWave NRD apparatus 56 has a fixed offset configuration of its processing rotors and other fixed design components and is therefore not configurable as the new art PulseWave QD apparatus 1 and not capable of as many adjustments that affect resonance and other forces.

Processing of hemp materials, particularly hemp stalks, using implementations of the PulseWave QD apparatus 1 and the PulseWave NRD 56 apparatus in conjunction with resonance disintegration and sometimes other PulseWave QD Forces according to the methods of the present disclosure can selectively result in the liberation of hurd material in implementations of the apparatus without substantial impact with machine surfaces such that the hurd material can also be selectively reduced to smaller particles and without being crushed or partially destroyed in the process. Much less energy is expended in practice of the present processes in the production of the present compositions of matter in the formation of clean, naturally cleaved products as compared to processing in prior art kinetic devices sometimes in conjunction with retting or other processes. The resistance to rancidity or spoilage of hurd materials liberated according to the methods of the present disclosure appears to be due to a possible distribution and integration of natural antioxidants as well as a reduction in natural enzyme degradation resulting from comminution of hemp materials from the inside out without crushing and bruising. Advantages so noted appear to occur due to the retention of natural components in a form present in the hemp itself. Hurd material with relatively narrow particle distribution curves result according to the processes of the present disclosure. Processing materials in implementations of the PulseWave apparatuses exhibits numerous advantages over conventional mechanical grinding or mechanical impact comminution apparatus and prior art devices.

As an example, the PulseWave apparatuses referred to herein, with or without the modifications inherent to the new art PulseWave QD apparatus 1 of the disclosure, can be operated at different speeds, in different rotational directions, and within a wide range of different frequencies as described herein such as to cause the liberation of the hemp fiber and the hemp hurd from the hemp stalk in an efficient, low-energy process that preserves the integrity and quality of the source materials.

The methods of the present disclosure further contemplate blending of additives with hemp materials either during or subsequent to the resonance decortication of the fiber and the hurd from the hemp stalk material and the liberation of the hurd material by subjection to processing using resonance disintegration and sometimes in concert with the PulseWave QD Forces to evenly distribute such additives within the materials, which additives can be fully blended and formed via a single processing pass through either PulseWave apparatus. Hemp hurd materials resulting from such processing are resistant to clumping and can easily be made more bioavailable as a result of its selective comminution to small sizes via the apparatus described herein.

Accordingly, methods of the present disclosure process hemp stalk materials to liberate the hemp fiber and hemp hurd components and selectively comminution the components to smaller particle sizes by subjection to PulseWave QD Forces via processing such as can include resonance disintegration processing in implementations of the PulseWave apparatuses. The methods of the present disclosures further produce hemp hurds from hemp stalk materials, the hurds being resistant to clumping and spoilage and exhibiting low structural damage while being characterized by favorable availability for commercial use as ingredients in various products and other utility. The methods of the present disclosures further process hemp materials via substantially non-impact processing with favorable energy expenditure relative to prior hemp component production methodologies.

The methods of the present disclosure separate the bast fiber and the hurd components from raw hemp stalk material whereby the resulting liberated fiber materials may, if comminuted according to present disclosure via implementations of the PulseWave apparatuses, be suitable for use as components or pre-components for nonwoven geotextiles/matting, non-woven insulation, fiberglass substitutes, industrial fabrics, automotive components (such as door panels, dashboards, etc.), shoes, ropes, clothing and textiles, and supercapacitors having characteristics not previously known in the art. The resulting liberated hurd materials may, if comminuted according to present disclosure via implementations of the PulseWave apparatuses, be suitable for use as components or pre-components for bioplastics, plastic additives, absorbents, animal bedding, animal litter, mulch & biochar, wood substitutes, paper & pulp, hemperete, particleboard, cellulose, and as components in lime plaster having characteristics not previously known in the art.

Processing according to the present disclosure permits separation of hemp bast fiber and hurd that, when produced according to the methods of the present disclosure, exhibit high quality with characteristics as noted herein. The methodology of the present disclosure comprises subjection of hemp stalk materials to alternating increasing and decreasing pressures, which may include shock waves, with abrupt directional changes in a high velocity stream to produce essentially instantaneous changes in forces acting thereon, thereby to reduce the material so processed along natural cleavage planes and along physiochemical boundaries therein with a resulting liberation of the hemp fibers and hurd from the stalk materials being processed. The methods of the present disclosure may be practiced within the new art PulseWave QD apparatus 1 of the disclosure and by apparatus such as disclosed in the aforesaid United States patents incorporated herein by reference, which may be modified as described herein, such processing occurring in a substantially non-mechanical impact or low-mechanical impact manner with energy efficiencies not possible with processes involving retting and crushing of hemp materials by conventional processing. In the methods of the present disclosure, hemp bast fibers and hurd materials are decorticated and liberated from the hemp stalk and from one another while effectively avoiding mechanical crushing as occurs with hammer mills, pin mills, ball mills, knife mills and the like which invariably cause damage among other deleterious effects.

The methods and processes of the present disclosure apply not only to hemp material, but also apply to virtually all biological materials composed of cells, including herbal, medicinal and food plants and fungi, and can be applied to kenaf and Cannabis plant stalks in a similar manner to hemp stalks. Any part of a plant can be processed, including, leaves, stems, roots, bark, and seeds. Fungal matter, such as mushrooms, can be processed in whole or in part. Herbals that can be processed accordingly to liberate intracellular materials including, by way of example and without limitation: Alfalfa (Medicago sativa); almonds (Prunus amygdalus); aloe vera (Aloe barbodenis, several strains and related species); angelica (Angelica archangelica); anise (Pimpinella anisum); arnica (Amica montana); artichoke (Cynara scalymus); astragalus (Astragalus membranaceous); basil (Ocimum basilicum); bayberry bark (Myrica certifera); bil-berry (Vaccinium myrtillus), black cohosh (Cimicifuga racemosa); black walnut (Juglans nigra); blessed thistle (Cnisus benedictus); boneset (Eupatrorium perfoliatum); borage (Baraga officinalis); buchu (Barosma betulina); bur-dock (Arctium zappa); butcher broom (Ruscus acluteatus); calendula (Calendula officinalis); cardamon (Elletaria cardamonuum); cayenne (Capsicum frutenscens); caraway (Carum carui); catnip (Nepeta cataria); chamomile (Matricaria chamomilla); chaparral (Larrea tridentata); chaste tree (Verbenaceae); chickweed (Stellaria media); chives (Allium schoenoprasum); cloves (Caryophyllum aromaticus); comfrey (Symphytum officinale); cranberry (Vaccinium macrocarpon); damiana (Turnea aphrodisiaca); devil's claw (Harpagophytum procumbens); dill (Anethum graveolens); dong quai (Angelica sinensis); echinacea (Echinacea angustifolia); ephedra (Ephedra sinica); euca-lyptus (Eucalyptus globulus); evening primrose (Oenothera biennis); eyebright (Euphrasin officinalis); fennel (Foeniculum vulgare); fenugreek (Trigonella graecum); feverfew (Chrysanthemum parthenium); Fo-Ti (Polygonum multiforum); garlic (Allium salivum); ginger (Zangiber officinale); ginko (Ginkgo biloba); ginseng (Panox ginseng, Panax quinquefolius); golden seal (Hydroastis canadensis); gotu kola (Centella asiatica); hawthorne berry (Crataegus oxyacantha); hops (Humulus lupulus); horse chestnut (Aesculus hippocastum); horse tail (Equisetum arvense); jasmine (Jasminum officinale); juniper berry (Junipera communis); kava (Piper methysticum); lady's mantle (Alchemilla vulgaris); lavender (Lavendula officinalis); lemon balm (Melissa officinalis); licorice (Glycyrrhiza globra); marshmallow (Althea officinalis); marijuana (Cannabis marijuana); meadow sweet (Filipenda ulmaria); milk thistle (Cardus marianus); mullein (Verbascum thapsus); mustard (Brassica hirta); myrrh (Commiphora myrrha); nettle (Urtica dioicu); noni (Indian mulberry) (Marinda citrifolia); oat fiber (Avena sativa); olive (Olea europaea); onion (Allim cepa); oregon grape (Mahonia aquifolium); osha (Ligusticum porteri); papaya (Carica papaya); parsley (Petroselinum sativum); passion flower (Passiflora incarnata); pennyroyal (Hedeoma pulegioides); peppermint (Mentha piprita); pleurisy root (Asclepias tuberosa); psyllium (Plantago psyllium); raspberry leaves (Rubus idoeus); red clover (Trifolium pratense); rosemary (Rosmarinus officinalis); sage (Salvia offininalis); St. John's wort (Hypericum perforatum); sarsaparilla (Similax officinalsis); saw palmetto (Serenosa serrulata); shiitake mushroom (Lentinus edodes); skull cap (Scutellaria lateriflora); suma (Pfaffia paniculats); thyme (Thymus vulgaris); tumeric (Circuma longa); uva ursi (Arctoslaphylosuva ursi); valerian (Valeriana officinalis); white willow bark (Salix alba); witch hazel (Hamamelis virginiana); yerba santo (Eriodictyon californicum); and yucca (Yucca liliaceae).

Materials processed according to the present disclosure produce compositions generally classified as hemp stalk materials, although raw hemp components of special grades are further included in the definition of hemp as referred to herein.

Compositions of matter according to the present disclosures include but are not limited to hemp bast fiber and hemp hurds of a particle size and moisture content resulting from processing of hemp stalks according to the present disclosure which are resistant to spoilage or contamination. The present disclosure further includes but is not limited to processes for production of fiber and hurd products having a particle size ranging from several millimeters to within a micron-sized range and which are resistant to clumping, such larger products being useable in commercial applications such as for horse bedding, or such smaller products being blendable with such additives and compounds as may be beneficial thereto for other commercial uses such as, for example, in hemperete and bioplastics production, such additives and compounds being essentially fully blended without clumping by single step processing that can include resonance decortication and liberation of the hemp fiber and hurd from the basic stalk material in concert with additive blending.

In some methodology, it is beneficial to remove and liberate the hemp bast fiber from the hemp stalk at relatively lower rpm in the range generally of 500 to 2,500 rpm and then to alternatively reprocess the fiber or hurd materials in a separate pass at higher rpm in the range generally of 2,500 to 5,000 rpm using the methods of the present disclosures to facilitate greater comminution thereof to particles having mean values in a range of microns, these mean values being generally reducible as desired by one or multiple passes through a PulseWave apparatus as disclosed herein.

The particle size of the hemp materials and the additives blended with the hemp materials during processing, after production, or processed as a mixture of hemp materials and additives according to the present disclosures and can be simultaneously reduced to desired particle sizes ranging from several millimeters to a few microns with the degree of size reduction varying depending on applied frequencies, rotational speeds, direction of rotation, and other adjustable factors with the resulting mixture is consistent in the concentration of additives throughout the processed material.

Although the present disclosures and implementations thereof have been described in detail, it should be understood that various changes, substitutions and alterations may be made herein without departing from the spirit and scope of the disclosure as defined by the appended claims. Moreover, the scope of the present application is not intended to be limited to the particular implementations of the process, machine, manufacture, composition of matter, means, methods and steps described in the specifications. As one of ordinary skill in the art will readily appreciate from the disclosures, processes, machines, manufacture, compositions of matter, means, methods, or steps, presently existing or later to be developed that perform substantially the same function or achieve substantially the same result as the corresponding implementations described herein may be utilized according to the present disclosure. Accordingly, the appended claims are intended to include within their scope such processes, machines, manufacture, compositions of matter, means, methods, or steps and all such modifications, permutations, additions and sub-combinations as are within their true spirit.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Accordingly, it is to be understood that the methods of the present disclosure can be practiced other than as explicitly disclosed herein without departing from the scope of the present disclosure as intended and as recited in the claims appended hereto.

1. An apparatus comprising:
a plurality of sides formed of hinged, segmented outer doors;
a splined central rotating shaft extending longitudinally within the apparatus; and
a plurality of matching splined processing rotors selectively spaced apart and coupled to the central rotating shaft, each of said plurality of processing rotors contained within a different processing chamber within the apparatus;
wherein the apparatus is selectively configurable for processing different materials.

2. The apparatus of claim 1, wherein:
each of the hinged, segmented outer doors is rotationally moveable between an open position providing access to an interior of the apparatus and a closed position.

3. The apparatus of claim 2, further comprising:
components coupled to each of the hinged, segmented outer doors;
wherein the components are selectively configurable to define dimensions of the different processing chambers.

4. The apparatus of claim 3, wherein the components comprise:
a plurality of segmented divider plates spaced apart and extending radially inwardly from the hinged, segmented outer doors to define longitudinal limits of the different processing chambers within the apparatus;
wherein the plurality of segmented divider plates is selectively configurable to define three to six different processing chambers within the apparatus.

5. The apparatus of claim 4, wherein:
a set of the plurality of segmented divider plates extending radially inwardly from the hinged, segmented outer doors at one longitudinal location form an orifice around the central rotating shaft when the plurality of hinged, segmented outer doors is rotated to the closed position.

6. The apparatus of claim 4, wherein the components further comprise:
a plurality of Primary Vortex Flow Disrupter Pins, each of the Primary Vortex Disrupter Pins extending between two longitudinally adjacent segmented divider plates to set the spacing therebetween.

7. The apparatus of claim 6, wherein:
the plurality of Primary Vortex Flow Disrupter Pins vary in length.

8. The apparatus of claim 1, further comprising:
a plurality of matched splined shaft spacers spaced apart and coupled to the central rotating shaft, each of the plurality of splined shaft spacers extending between two longitudinally adjacent processing rotors to set the spacing therebetween.

9. The apparatus of claim 8, wherein:
the plurality of splined shaft spacers vary in length.

10. The apparatus of claim 1, wherein:
each of the plurality of processing rotors is rotationally alignable on the central rotating shaft for angular offset from adjacent processing rotors.

11. The apparatus of claim 1, wherein:
at least one of the processing rotors comprises a plurality of processing rotor vanes extending radially inwardly from an apex.

12. The apparatus of claim 1, wherein:
at least one of the processing rotors comprises a scalloped side.

13. The apparatus of claim 1, wherein:
the plurality of processing rotors vary in diameter.

14. An apparatus comprising:
a plurality of hinged, segmented outer doors, each door being separately rotatable to an open position to allow access to an interior of the apparatus;
a plurality of processing chambers spaced longitudinally within the interior of apparatus; and
a plurality of processing rotors spaced longitudinally within the interior of the apparatus, each of the processing rotors being contained within a different processing chamber of the plurality of processing chambers;
wherein the apparatus is selectively configurable to define three to six different processing chambers within the interior of the apparatus.

15. The apparatus of claim 14, wherein:
the apparatus is selectively configurable to define spacing between adjacent processing rotors of the plurality of processing rotors.

16. The apparatus of claim 14, wherein:
the apparatus is selectively configurable to rotationally align each processing rotor to define an angular offset from adjacent processing rotors of the plurality of processing rotors.

17. The apparatus of claim 14, wherein:
the plurality of processing rotors vary in diameter.

18. An apparatus comprising:
a plurality of hinged, segmented outer doors coupled together to form a housing;
wherein the plurality of hinged, segmented outer doors are selectively reconfigurable to form three to six processing chambers within the housing.

19. The apparatus of claim 18, wherein:
the plurality of hinged, segmented outer doors define a location of each processing chamber within the housing.

20. The apparatus of claim 18, wherein:
the plurality of hinged, segmented outer doors define a size of each processing chamber within the housing.
